(19) United States
(12) Patent Application Publication
(10) Pub. No.: US 2024/0118525 A1
(43) Pub. Date: Apr. 11, 2024

(54) ZOOM OPTICAL SYSTEM, OPTICAL APPARATUS AND METHOD FOR MANUFACTURING THE ZOOM OPTICAL SYSTEM

(71) Applicant: Nikon Corporation, Minato-ku (JP)

(72) Inventors: Tomoyuki SASHIMA, Tokyo (JP); Takahiro ISHIKAWA, Kanagawa (JP); Fumiaki OHTAKE, Tokyo (JP)

(21) Appl. No.: 18/276,028

(22) PCT Filed: Feb. 17, 2022
(86) PCT No.: PCT/JP2022/006338

§ 371 Date: Aug. 5, 2023

(30) Foreign Application Priority Data
Apr. 15, 2021 (JP) 2021-069018

(51) Int. Cl. G02B 15/14; G02B 13/02

(52) U.S. Cl. CPC G02B 15/144515; G02B 13/02

(57) ABSTRACT

A variable magnification optical system (ZL) comprises a first lens group (G1) having negative refractive power, and a rear group (GR) having at least one lens group, the distance between lens groups adjacent to each other changes when the magnification is changed, and the following conditional expression is satisfied. 0.90<TLt/ft<1.50 where TLt is the total length of the variable magnification optical system (ZL) in a telephoto end state, and ft is the focal distance of the variable magnification optical system (ZL) in the telephoto end state.

### TECHNICAL FIELD

The present invention relates to a zoom optical system, an optical apparatus, and a method for manufacturing the zoom optical system.

### TECHNICAL BACKGROUND

Conventionally, a zoom optical system that is suitable for a photographing camera, an electronic still camera, a video camera, and the like has been proposed (for example, refer to Patent literature 1). With such a zoom optical system, it is difficult to achieve favorable optical performance with a small size.

### PRIOR ARTS LIST

### Patent Document

Patent literature 1: International Patent Publication No. 2020/012638A1

### SUMMARY OF THE INVENTION

A zoom optical system according to a first present invention comprises a first lens group and a rear group arranged in order from an object side along an optical axis, the first lens group having negative refractive power, the rear group including at least one lens group. A space between lens groups adjacent to each other changes at zooming. The following conditional expression is satisfied,

0.90<TLt/ft<1.50
where,
TLt: entire length of the zoom optical system in a telephoto end state, and
ft: focal length of the zoom optical system in the telephoto end state.

A zoom optical system according to a second present invention comprises a first lens group and a rear group arranged in order from an object side along an optical axis, the first lens group having negative refractive power, the rear group including at least one lens group. A space between lens groups adjacent to each other changes at zooming. The following conditional expression is satisfied,

1.50<TLw/fw<2.30
where,
TLw: entire length of the zoom optical system in a wide-angle end state, and
fw: focal length of the zoom optical system in the wide-angle end state.

A zoom optical system according to a third present invention comprises a first lens group and a rear group arranged in order from an object side along an optical axis, the first lens group having negative refractive power, the rear group including at least one lens group. A space between lens groups adjacent to each other changes at zooming. The following conditional expression is satisfied,

0.50<(−f1)/TLw<1.50
where,
f1: focal length of the first lens group, and
TLw: entire length of the zoom optical system in a wide-angle end state.

A zoom optical system according to a fourth present invention comprises a first lens group and a rear group arranged in order from an object side along an optical axis, the first lens group having negative refractive power, the rear group including at least one lens group. A space between lens groups adjacent to each other changes at zooming. The following conditional expression is satisfied,

0.35<(−f1)/TLt<1.25
where,
f1: focal length of the first lens group, and
TLt: entire length of the zoom optical system in a telephoto end state.

An optical apparatus according to the present invention comprises an above-described zoom optical system.

A method for manufacturing a zoom optical system according to a first present invention which comprises a first lens group and a rear group arranged in order from an object side along an optical axis, the first lens group having negative refractive power, the rear group including at least one lens group, comprising a step for arranging the lens groups in a lens barrel so that;
a space between lens groups adjacent to each other changes at zooming, and
the following conditional expression is satisfied,

0.90<TLt/ft<1.50
where,
TLt: entire length of the zoom optical system in a telephoto end state, and
ft: focal length of the zoom optical system in the telephoto end state.

A method for manufacturing a zoom optical system according to a second present invention which comprises a first lens group and a rear group arranged in order from an object side along an optical axis, the first lens group having negative refractive power, the rear group including at least one lens group, comprising a step for arranging the lens groups in a lens barrel so that;
a space between lens groups adjacent to each other changes at zooming, and
the following conditional expression is satisfied,

1.50<TLw/fw<2.30
where,
TLw: entire length of the zoom optical system in a wide-angle end state, and
fw: focal length of the zoom optical system in the wide-angle end state.

A method for manufacturing a zoom optical system according to a third present invention which comprises a first lens group and a rear group arranged in order from an object side along an optical axis, the first lens group having negative refractive power, the rear group including at least one lens group, comprising a step for arranging the lens groups in a lens barrel so that;
a space between lens groups adjacent to each other changes at zooming, and
the following conditional expression is satisfied,

0.50<(−f1)/TLw<1.50
where,
f1: focal length of the first lens group, and
TLw: entire length of the zoom optical system in a wide-angle end state.

A method for manufacturing a zoom optical system according to a fourth present invention which comprises a first lens group and a rear group arranged in order from an object side along an optical axis, the first lens group having negative refractive power, the rear group including at least one lens group, comprising a step for arranging the lens groups in a lens barrel so that;
a space between lens groups adjacent to each other changes at zooming, and
the following conditional expression is satisfied,

0.35<(−f1)/TLt<1.25
where,
f1: focal length of the first lens group, and
TLt: entire length of the zoom optical system in a telephoto end state.

### BRIEF DESCRIPTION OF THE DRAWINGS

FIG. 1 is a diagram showing a lens configuration of a zoom optical system according to a first example;

FIGS. 2A and 2B show a variety of aberration diagrams of the zoom optical system according to the first example upon focusing on infinity in a wide-angle end state and a telephoto end state, respectively;

FIG. 3 is a diagram showing a lens configuration of a zoom optical system according to a second example;

FIGS. 4A and 4B show a variety of aberration diagrams of the zoom optical system according to the second example upon focusing on infinity in a wide-angle end state and a telephoto end state, respectively;

FIG. 5 is a diagram showing a lens configuration of a zoom optical system according to a third example;

FIGS. 6A and 6B show a variety of aberration diagrams of the zoom optical system according to the third example upon focusing on infinity in a wide-angle end state and a telephoto end state, respectively;

FIG. 7 is a diagram showing a lens configuration of a zoom optical system according to a fourth example;

FIGS. 8A and 8B show a variety of aberration diagrams of the zoom optical system according to the fourth example upon focusing on infinity in a wide-angle end state and a telephoto end state, respectively;

FIG. 9 is a diagram showing a lens configuration of a zoom optical system according to a fifth example;

FIGS. 10A and 10B show a variety of aberration diagrams of the zoom optical system according to the fifth example upon focusing on infinity in a wide-angle end state and a telephoto end state, respectively;

FIG. 11 is a diagram showing a lens configuration of a zoom optical system according to a sixth example;

FIGS. 12A and 12B show a variety of aberration diagrams of the zoom optical system according to the sixth example upon focusing on infinity in a wide-angle end state and a telephoto end state, respectively;

FIG. 13 is a diagram showing a lens configuration of a zoom optical system according to a seventh example;

FIGS. 14A and 14B show a variety of aberration diagrams of the zoom optical system according to the seventh example upon focusing on infinity in a wide-angle end state and a telephoto end state, respectively;

FIG. 15 is a diagram showing a lens configuration of a zoom optical system according to an eighth example;

FIGS. 16A and 16B show a variety of aberration diagrams of the zoom optical system according to the eighth example upon focusing on infinity in a wide-angle end state and a telephoto end state, respectively;

FIG. 17 is a diagram showing a lens configuration of a zoom optical system according to a ninth example;

FIGS. 18A and 18B show a variety of aberration diagrams of the zoom optical system according to the ninth example upon focusing on infinity in a wide-angle end state and a telephoto end state, respectively;

FIG. 19 is a diagram showing a lens configuration of a zoom optical system according to a tenth example;

FIGS. 20A and 20B show a variety of aberration diagrams of the zoom optical system according to the tenth example upon focusing on infinity in a wide-angle end state and a telephoto end state, respectively;

FIG. 21 is a diagram showing a lens configuration of a zoom optical system according to an eleventh example;

FIGS. 22A and 22B show a variety of aberration diagrams of the zoom optical system according to the eleventh example upon focusing on infinity in a wide-angle end state and a telephoto end state, respectively;

FIG. 23 is a diagram showing the configuration of a camera comprising the zoom optical system according to each embodiment; and

FIG. 24 is a flowchart showing a method for manufacturing the zoom optical system according to each embodiment.

### DESCRIPTION OF THE EMBODIMENTS

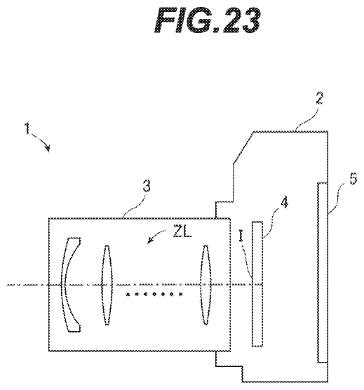

Preferable embodiments according to the present invention will be described below. First, a camera (optical apparatus) comprising a zoom optical system according to each embodiment will be described with reference to FIG. 23. As shown in FIG. 23, this camera 1 comprises a body 2 and a photographing lens 3 mounted on the body 2. The body 2 includes an image capturing element 4, a body control part (not shown) configured to control digital camera operation, and a liquid crystal screen 5. The photographing lens 3 includes a zoom optical system ZL including a plurality of lens groups, and a lens position control mechanism (not shown) configured to control the position of each lens group. The lens position control mechanism includes a sensor configured to detect the position of each lens group, a motor configured to move each lens group forward and backward along an optical axis, and a control circuit configured to drive the motor.

Light from an object is collected by the zoom optical system ZL of the photographing lens 3 and incident on an image surface I of the image capturing element 4. After being incident on the image surface I, the light from the object is photoelectrically converted by the image capturing element 4 and recorded as digital image data in a non-shown memory. The digital image data recorded in the memory can be displayed on the liquid crystal screen 5 in accordance with an operation by a user. Note that the camera may be a mirrorless camera or may be a single-lens reflex type camera including a quick return mirror. The zoom optical system ZL shown in FIG. 23 schematically indicates the zoom optical system included in the photographing lens 3, and a lens configuration of the zoom optical system ZL is not limited to this configuration.

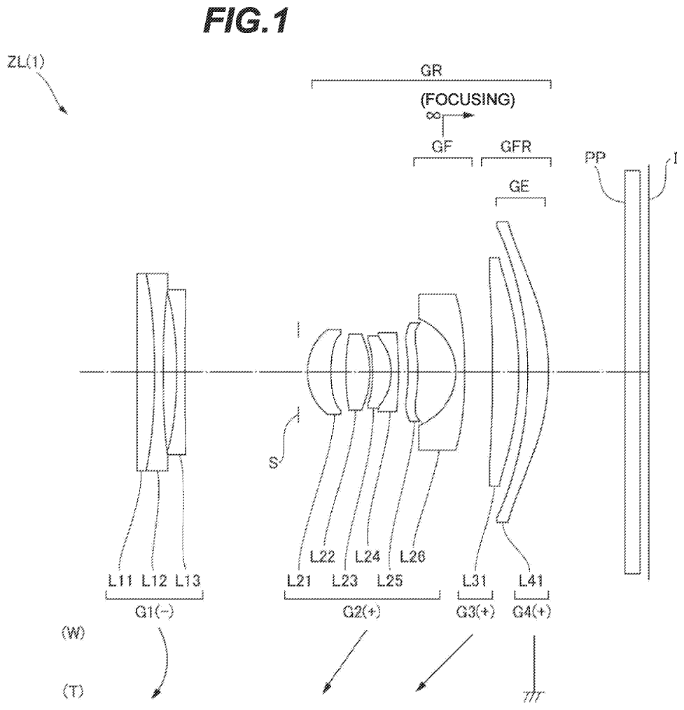

A zoom optical system according to a first embodiment will be described below. As shown in FIG. 1, a zoom optical system ZL(1) as an exemplary zoom optical system (zoom lens) ZL according to the first embodiment comprises a first lens group G1 and a rear group GR arranged in order from an object side along an optical axis, the first lens group G1 having negative refractive power, the rear group GR including at least one lens group. A space between the lens groups adjacent to each other changes at zooming.

With the above-described configuration, the zoom optical system ZL according to the first embodiment satisfies the following Conditional Expression (1).

0.90<TLt/ft<1.50 (1)
Where,
TLt: entire length of the zoom optical system ZL in a telephoto end state, and
ft: focal length of the zoom optical system ZL in the telephoto end state.

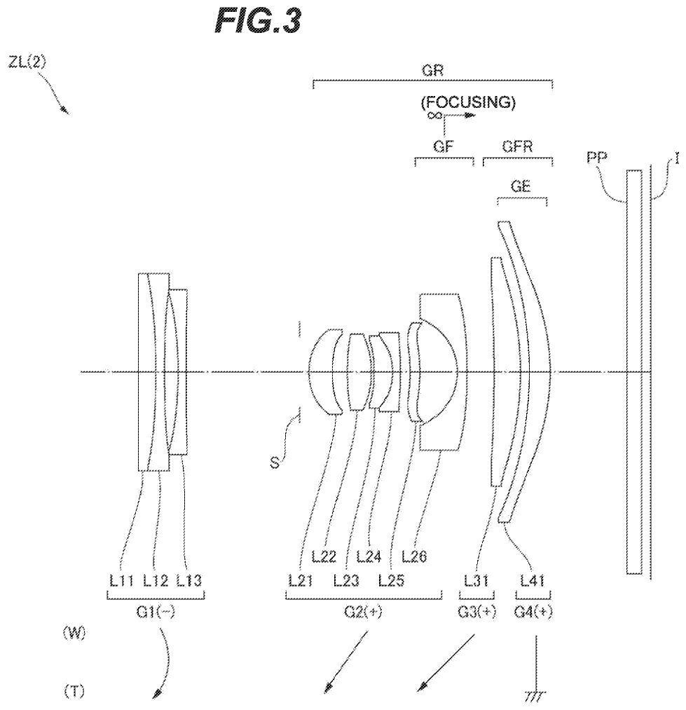

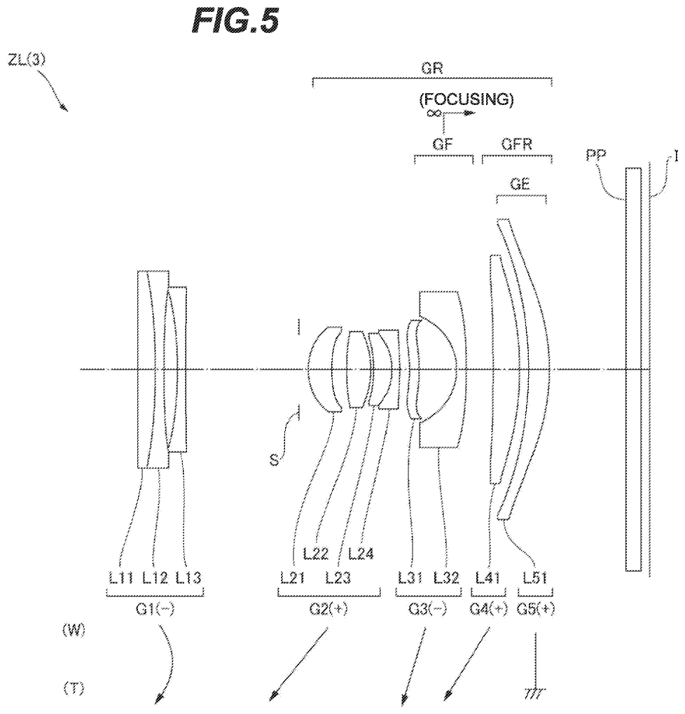

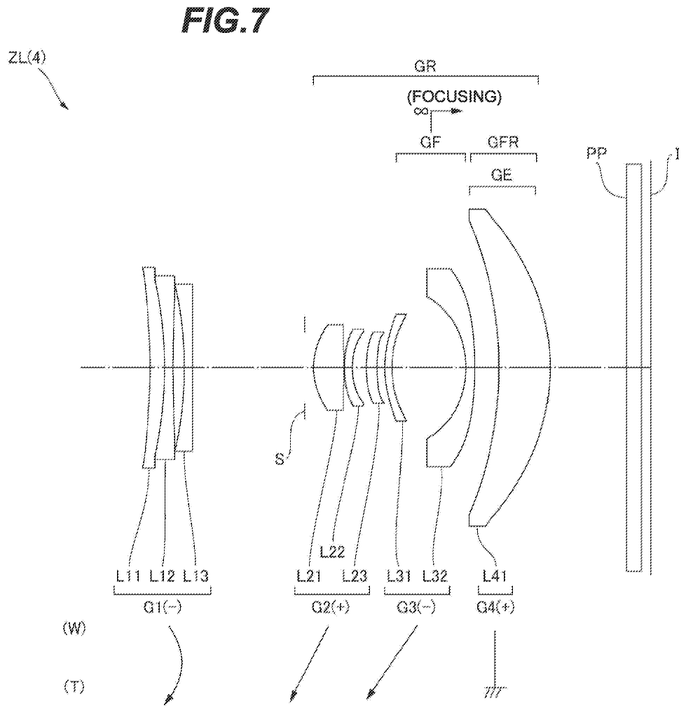

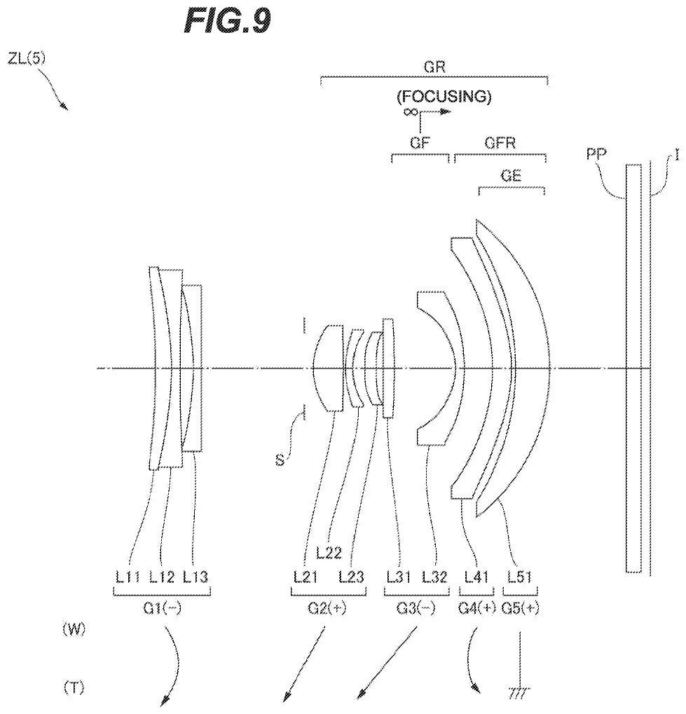

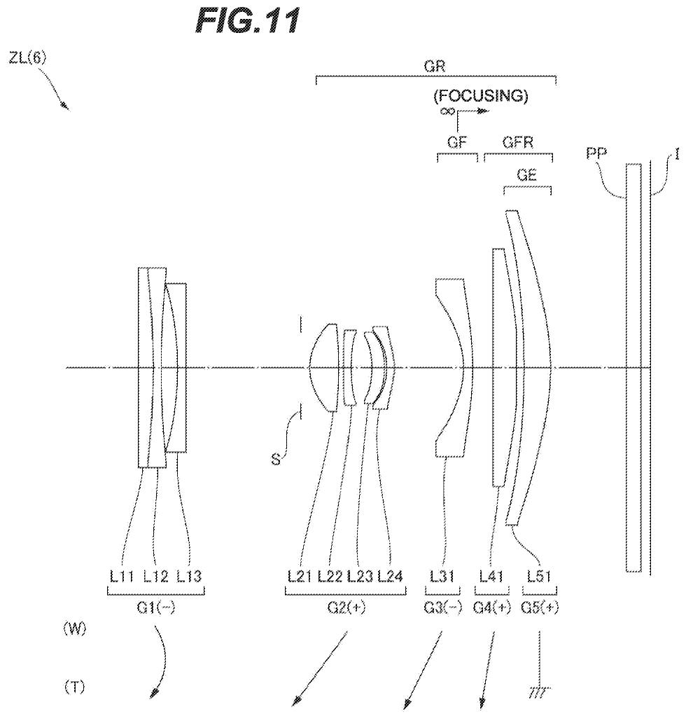

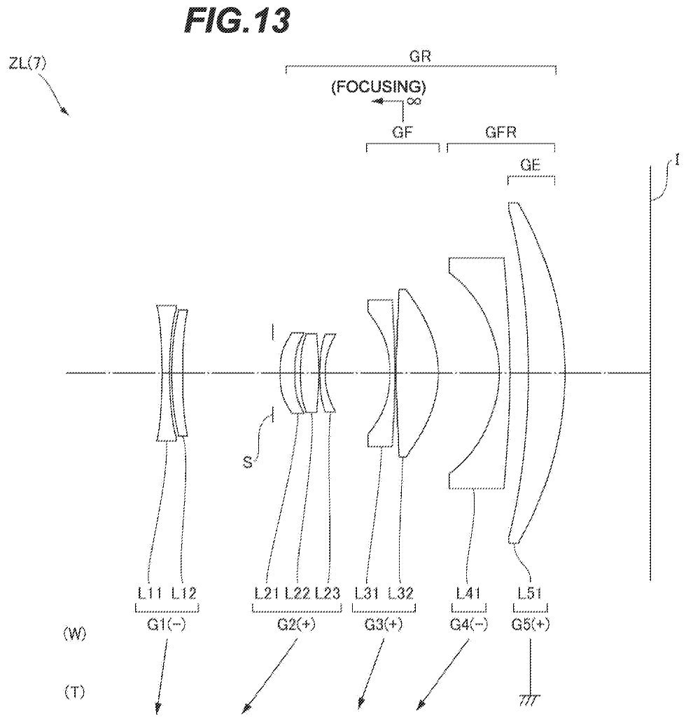

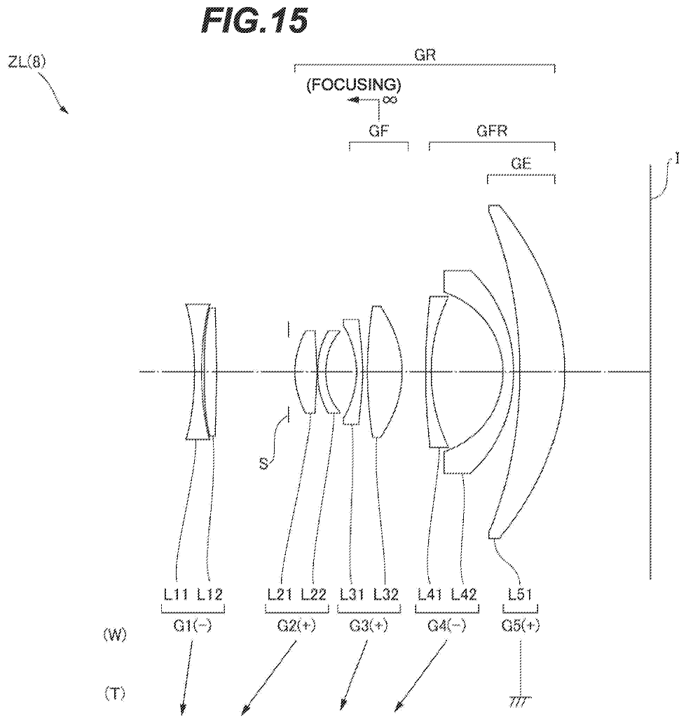

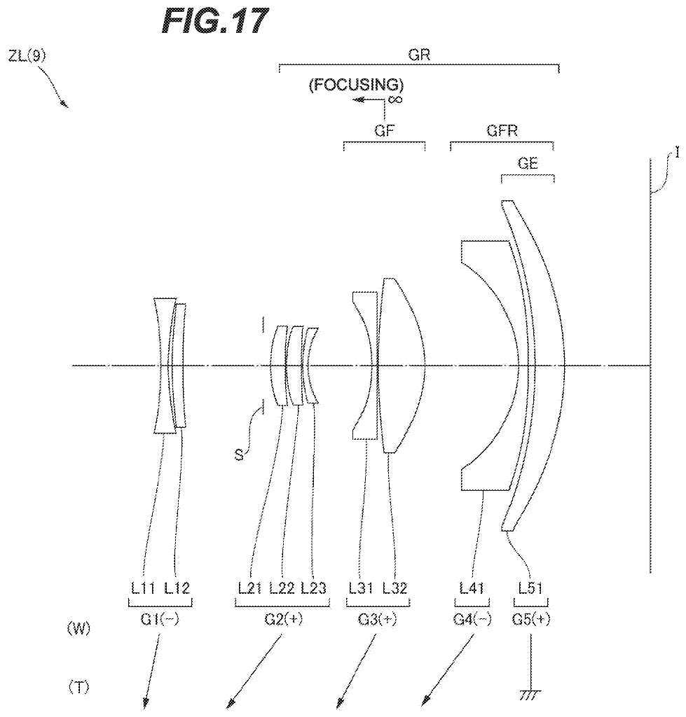

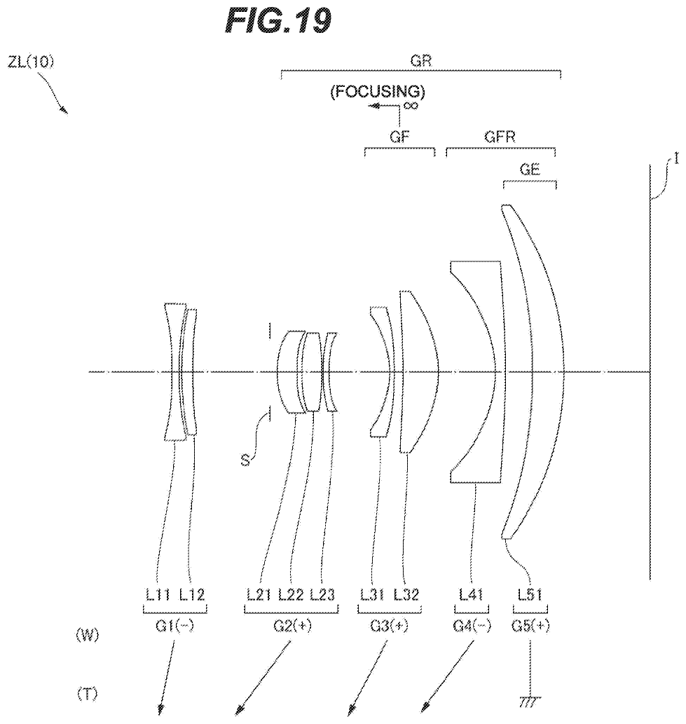

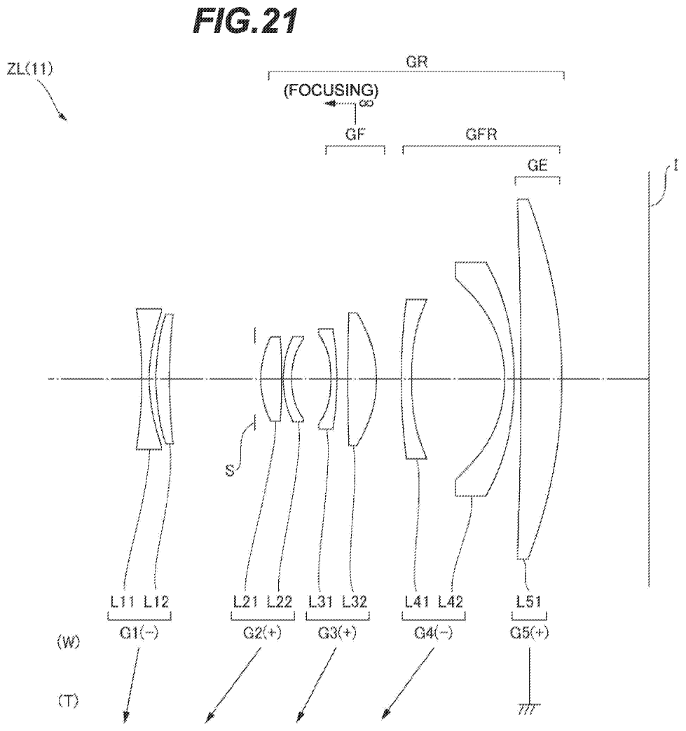

According to the first embodiment, it is possible to obtain a zoom optical system having favorable optical performance with a small size, and an optical apparatus comprising the zoom optical system. The zoom optical system ZL according to the first embodiment may be a zoom optical system ZL(2) shown in FIG. 3, may be a zoom optical system ZL (3) shown in FIG. 5, may be a zoom optical system ZL(4) shown in FIG. 7, may be a zoom optical system ZL(5) shown in FIG. 9, and may be a zoom optical system ZL(6) shown in FIG. 11. Moreover, the zoom optical system ZL according to the first embodiment may be a zoom optical system ZL(7) shown in FIG. 13, may be a zoom optical system ZL(8) shown in FIG. 15, may be a zoom optical system ZL(9) shown in FIG. 17, may be a zoom optical system ZL (10) shown in FIG. 19, and may be a zoom optical system ZL (11) shown in FIG. 21.

Conditional Expression (1) defines an appropriate relation between the entire length of the zoom optical system ZL in the telephoto end state and the focal length of the zoom optical system ZL in the telephoto end state. When satisfying Conditional Expression (1), the zoom optical system ZL with a small size can excellently correct a variety of aberrations such as spherical aberration, coma aberration, and curvature of field. Note that the entire length of the zoom optical system ZL in each embodiment is the distance on the optical axis from a lens surface closest to the object side in the zoom optical system ZL to the image surface I (however, the distance on the optical axis from a lens surface disposed closest to an image side in the zoom optical system ZL to the image surface I is an air equivalent distance) upon focusing on infinity.

When the correspondence value of Conditional Expression (1) is out of the above-described range, it is difficult to correct a variety of aberrations through the zoom optical system ZL with a small size. It is possible to secure the advantageous effect of the present embodiment by setting the upper limit value of Conditional Expression (1) to 1.45, 1.40, 1.35, 1.30, 1.25, 1.20 or 1.17. Moreover, it is possible to secure the advantageous effect of the present embodiment by setting the lower limit value of Conditional Expression (1) to 0.95, 1.00, 1.03, 1.05, 1.08, or 1.10.

A zoom optical system according to a second embodiment will be described below. As shown in FIG. 1, a zoom optical system ZL(1) as an exemplary zoom optical system (zoom lens) ZL according to the second embodiment comprises a first lens group G1 and a rear group GR arranged in order from an object side along an optical axis, the first lens group G1 having negative refractive power, the rear group GR including at least one lens group. A space between the lens groups adjacent to each other changes at zooming.

With the above-described configuration, the zoom optical system ZL according to the second embodiment satisfies the following Conditional Expression (2).

1.50<TLw/fw<2.30 (2)
Where,
TLw: entire length of the zoom optical system ZL in a wide-angle end state, and
fw: focal length of the zoom optical system ZL in the wide-angle end state.

According to the second embodiment, it is possible to obtain a zoom optical system having favorable optical performance with a small size, and an optical apparatus comprising the zoom optical system. The zoom optical system ZL according to the second embodiment may be a zoom optical system ZL(2) shown in FIG. 3, may be a zoom optical system ZL (3) shown in FIG. 5, may be a zoom optical system ZL(4) shown in FIG. 7, may be a zoom optical system ZL(5) shown in FIG. 9, and may be a zoom optical system ZL(6) shown in FIG. 11. Moreover, the zoom optical system ZL according to the second embodiment may be a zoom optical system ZL(7) shown in FIG. 13, may be a zoom optical system ZL(8) shown in FIG. 15, may be a zoom optical system ZL(9) shown in FIG. 17, may be a zoom optical system ZL (10) shown in FIG. 19, and may be a zoom optical system ZL (11) shown in FIG. 21.

Conditional Expression (2) defines an appropriate relation between the entire length of the zoom optical system ZL in the wide-angle end state and the focal length of the zoom optical system ZL in the wide-angle end state. When satisfying Conditional Expression (2), the zoom optical system ZL with a small size can excellently correct a variety of aberrations such as spherical aberration, coma aberration, and curvature of field.

When the correspondence value of Conditional Expression (2) is out of the above-described range, it is difficult to correct a variety of aberrations through the zoom optical system ZL with a small size. It is possible to secure the advantageous effect of the present embodiment by setting the upper limit value of Conditional Expression (2) to 2.25, 2.20, 2.15, 2.10, 2.05, 2.00 or 1.95. Moreover, it is possible to secure the advantageous effect of the present embodiment by setting the lower limit value of Conditional Expression (2) to 1.55, 1.60, 1.65, 1.70, 1.75, or 1.80.

A zoom optical system according to a third embodiment will be described below. As shown in FIG. 1, a zoom optical system ZL(1) as an exemplary zoom optical system (zoom lens) ZL according to the third embodiment comprises a first lens group G1 and a rear group GR arranged in order from an object side along an optical axis, the first lens group G1 having negative refractive power, the rear group GR including at least one lens group. A space between the lens groups adjacent to each other changes at zooming.

With the above-described configuration, the zoom optical system ZL according to the third embodiment satisfies the following Conditional Expression (3).

0.50<(−f1)/TLw<1.50 (3)
Where,
f1: focal length of the first lens group G1, and
TLw: entire length of the zoom optical system ZL in a wide-angle end state.

According to the third embodiment, it is possible to obtain a zoom optical system having favorable optical performance with a small size, and an optical apparatus comprising the zoom optical system. The zoom optical system ZL according to the third embodiment may be a zoom optical system ZL(2) shown in FIG. 3, may be a zoom optical system ZL (3) shown in FIG. 5, may be a zoom optical system ZL(4) shown in FIG. 7, may be a zoom optical system ZL(5) shown in FIG. 9, and may be a zoom optical system ZL(6) shown in FIG. 11. Moreover, the zoom optical system ZL according to the third embodiment may be a zoom optical system ZL(7) shown in FIG. 13, may be a zoom optical system ZL(8) shown in FIG. 15, may be a zoom optical system ZL(9) shown in FIG. 17, may be a zoom optical system ZL (10) shown in FIG. 19, and may be a zoom optical system ZL (11) shown in FIG. 21.

Conditional Expression (3) defines an appropriate relation between the focal length of the first lens group G1 and the entire length of the zoom optical system ZL in the wide-angle end state. When satisfying Conditional Expression (3), the zoom optical system ZL with a small size can excellently correct a variety of aberrations such as spherical aberration, coma aberration, and curvature of field.

When the correspondence value of Conditional Expression (3) is out of the above-described range, it is difficult to correct a variety of aberrations through the zoom optical system ZL with a small size. It is possible to secure the advantageous effect of the present embodiment by setting the upper limit value of Conditional Expression (3) to 1.40, 1.30, 1.25, 1.20, 1.15, or 1.10. Moreover, it is possible to secure the advantageous effect of the present embodiment by setting the lower limit value of Conditional Expression (3) to 0.55, 0.60, 0.65, 0.70, or 0.73.

A zoom optical system according to a fourth embodiment will be described below. As shown in FIG. 1, a zoom optical system ZL(1) as an exemplary zoom optical system (zoom lens) ZL according to the fourth embodiment comprises a first lens group G1 and a rear group GR arranged in order from an object side along an optical axis, the first lens group G1 having negative refractive power, the rear group GR including at least one lens group. A space between the lens groups adjacent to each other changes at zooming.

With the above-described configuration, the zoom optical system ZL according to the fourth embodiment satisfies the following Conditional Expression (4).

0.35<(−f1)/TLt<1.25 (4)
Where,
f1: focal length of the first lens group G1, and
TLt: entire length of the zoom optical system ZL in a telephoto end state.

According to the fourth embodiment, it is possible to obtain a zoom optical system having favorable optical performance with a small size, and an optical apparatus comprising the zoom optical system. The zoom optical system ZL according to the fourth embodiment may be a zoom optical system ZL(2) shown in FIG. 3, may be a zoom optical system ZL (3) shown in FIG. 5, may be a zoom optical system ZL(4) shown in FIG. 7, may be a zoom optical system ZL(5) shown in FIG. 9, and may be a zoom optical system ZL(6) shown in FIG. 11. Moreover, the zoom optical system ZL according to the fourth embodiment may be a zoom optical system ZL(7) shown in FIG. 13, may be a zoom optical system ZL(8) shown in FIG. 15, may be a zoom optical system ZL(9) shown in FIG. 17, may be a zoom optical system ZL(10) shown in FIG. 19, and may be a zoom optical system ZL (11) shown in FIG. 21.

Conditional Expression (4) defines an appropriate relation between the focal length of the first lens group G1 and the entire length of the zoom optical system ZL in the telephoto end state. When satisfying Conditional Expression (4), the zoom optical system ZL with a small size can excellently correct a variety of aberrations such as spherical aberration, coma aberration, and curvature of field.

When the correspondence value of Conditional Expression (4) is out of the above-described range, it is difficult to correct a variety of aberrations through the zoom optical system ZL with a small size. It is possible to secure the advantageous effect of the present embodiment by setting the upper limit value of Conditional Expression (4) to 1.20, 1.15, 1.10, 1.08, 1.05, or 1.03. Moreover, it is possible to secure the advantageous effect of the present embodiment by setting the lower limit value of Conditional Expression (4) to 0.40, 0.45, 0.50, 0.55, 0.60, or 0.65.

In the zoom optical system ZL according to each of the first to fourth embodiments, at least part of any one lens group in the at least one lens group of the rear group GR is preferably a focusing group GF that moves along the optical axis upon focusing. Accordingly, the zoom optical system ZL with a small size can excellently correct a variety of aberrations.

In the zoom optical system ZL according to each of the first to fourth embodiments, the focusing group GF preferably has negative refractive power, and the following Conditional Expression (5) is preferably satisfied.

1.50<ft/(−fF)<10.00 (5)
Where,
ft: focal length of the zoom optical system ZL in the telephoto end state, and
fF: focal length of the focusing group GF.

Conditional Expression (5) defines an appropriate relation between the focal length of the zoom optical system ZL in the telephoto end state and the focal length of the focusing group GF having negative refractive power. When satisfying Conditional Expression (5), the zoom optical system ZL with a small size can reduce variation of spherical aberration, coma aberration, and curvature of field upon focusing on a close distance object.

When the correspondence value of Conditional Expression (5) is out of the above-described range, the moving amount of the focusing group GF is large and thus it is difficult to reduce variation of spherical aberration, coma aberration, and curvature of field upon focusing on a close distance object. It is possible to secure the advantageous effect of each embodiment by setting the upper limit value of Conditional Expression (5) to 8.50, 7.00, 6.00, 5.00, 4.75, 4.50, 4.25, 4.00, 3.85 or 3.70. Moreover, it is possible to secure the advantageous effect of each embodiment by setting the lower limit value of Conditional Expression (5) to 1.55, 1.60, 1.65, 1.70, 1.75, 1.80, 1.85, 1.90, or 1.95.

In the zoom optical system ZL according to each of the first to fourth embodiments, the focusing group GF preferably has negative refractive power, and the following conditional expression (6) is preferably satisfied.

0.70<fw/(−fF)<7.00 (6)
Where,
fw: focal length of the zoom optical system ZL in the wide-angle end state, and
fF: focal length of the focusing group GF.

Conditional Expression (6) defines an appropriate relation between the focal length of the zoom optical system ZL in the wide-angle end state and the focal length of the focusing group GF having negative refractive power. When satisfying Conditional Expression (6), the zoom optical system ZL with a small size can reduce variation of spherical aberration, coma aberration, and curvature of field upon focusing on a close distance object.

When the correspondence value of Conditional Expression (6) is out of the above-described range, the moving amount of the focusing group GF is large and thus it is difficult to reduce variation of spherical aberration, coma aberration, and curvature of field upon focusing on a close distance object. It is possible to secure the advantageous effect of each embodiment by setting the upper limit value of Conditional Expression (6) to 6.50, 6.00, 5.50, 5.00, 4.50, 4.00, 3.50, 3.00, 2.75, 2.50, 2.35, or 2.25. Moreover, it is possible to secure the advantageous effect of each embodiment by setting the lower limit value of Conditional Expression (6) to 0.75, 0.80, 0.85, 0.90, 0.95, 1.00, 1.05, 1.10 or 1.15.

In the zoom optical system ZL according to each of the first to fourth embodiments, the focusing group GF preferably has negative refractive power, and the following conditional expression (7) is preferably satisfied.

1.00<fFRw/(−fF)<7.00 (7)
Where,
fFRw: focal length of a lens group of lenses disposed closer to the image side than the focusing group GF in the wide-angle end state, and
fF: focal length of the focusing group GF.

Conditional Expression (7) defines an appropriate relation between the focal length of the lens group of lenses disposed closer to the image side than the focusing group GF in the wide-angle end state and the focal length of the focusing group GF having negative refractive power. Hereinafter, the lens group of lenses disposed closer to the image side than the focusing group GF is also referred to as an image-side lens group GFR. When satisfying Conditional Expression (7), the zoom optical system ZL with a small size can reduce variation of spherical aberration, coma aberration, and curvature of field upon focusing on a close distance object.

When the correspondence value of Conditional Expression (7) exceeds the upper limit value, the focal length of the focusing group GF is too short for the focal length of the image-side lens group GFR and thus it is difficult to reduce variation of spherical aberration, coma aberration, and curvature of field upon focusing on a close distance object. It is possible to secure the advantageous effect of each embodiment by setting the upper limit value of Conditional Expression (7) to 6.50, 6.00, 5.50, 5.00, 4.50, 4.00, 3.50, 3.25, 3.00, 2.75 or 2.50.

When the correspondence value of Conditional Expression (7) exceeds the lower limit value, the moving amount of the focusing group GF is large and thus it is difficult to reduce variation of spherical aberration, coma aberration, and curvature of field upon focusing on a close distance object. It is possible to secure the advantageous effect of each embodiment by setting the lower limit value of Conditional Expression (7) to 1.10, 1.20, 1.30, 1.40, 1.50, 1.55, 1.60, 1.65, 1.70, 1.75 or 1.80.

In the zoom optical system ZL according to each of the first to fourth embodiments, the focusing group GF preferably has negative refractive power, and the following conditional expression (8) is preferably satisfied.

1.00<fFRt/(−fF)<7.00 (8)
Where,
fFRt: focal length of the lens group of lenses disposed closer to the image side than the focusing group GF in the telephoto end state, and
fF: focal length of the focusing group GF.

Conditional Expression (8) defines an appropriate relation between the focal length of the lens group (image-side lens group GFR) of lenses disposed closer to the image side than the focusing group GF in the telephoto end state and the focal length of the focusing group GF having negative refractive power. When satisfying Conditional Expression (8), the zoom optical system ZL with a small size can reduce variation of spherical aberration, coma aberration, and curvature of field upon focusing on a close distance object.

When the correspondence value of Conditional Expression (8) exceeds the upper limit value, the focal length of the focusing group GF is too short for the focal length of the image-side lens group GFR and thus it is difficult to reduce variation of spherical aberration, coma aberration, and curvature of field upon focusing on a close distance object. It is possible to secure the advantageous effect of each embodiment by setting the upper limit value of Conditional Expression (8) to 6.50, 6.00, 5.50, 5.00, 4.50, 4.00, 3.50, 3.25, 3.00, 2.75 or to 2.50.

When the correspondence value of Conditional Expression (8) exceeds the lower limit value, the moving amount of the focusing group GF is large and thus it is difficult to reduce variation of spherical aberration, coma aberration, and curvature of field upon focusing on a close distance object. It is possible to secure the advantageous effect of each embodiment by setting the lower limit value of Conditional Expression (8) to 1.10, 1.20, 1.30, 1.40, 1.50, 1.60, 1.65, 1.70, 1.75, 1.80, 1.85, 1.90 or 1.95.

In the zoom optical system ZL according to each of the first to fourth embodiments, the focusing group GF preferably has negative refractive power, and the following conditional expression (9) is preferably satisfied.

0.50<fRPF/(−fF)<3.00 (9)
Where,
fRPF: focal length of a lens group having positive refractive power and disposed closest to the object side in the at least one lens group of the rear group GR, and
fF: focal length of the focusing group GF.

Conditional Expression (9) defines an appropriate relation between the focal length of the lens group having positive refractive power and disposed closest to the object side in the at least one lens group of the rear group GR and the focal length of the focusing group GF having negative refractive power. When satisfying Conditional Expression (9), the zoom optical system ZL with a small size can reduce variation of spherical aberration, coma aberration, and curvature of field upon focusing on a close distance object.

When the correspondence value of Conditional Expression (9) exceeds the upper limit value, the focal length of the focusing group GF is short and thus it is difficult to reduce variation of spherical aberration, coma aberration, and curvature of field upon focusing on a close distance object. It is possible to secure the advantageous effect of each embodiment by setting the upper limit value of Conditional Expression (9) to 2.75, 2.50, 2.25, 2.00, 1.85, 1.70, 1.60, 1.55, 1.50 or 1.48.

When the correspondence value of Conditional Expression (9) exceeds the lower limit value, the focal length of a lens group having positive refractive power and disposed closest to the object side in the rear group GR is short and thus it is difficult to correct spherical aberration and coma aberration. It is possible to secure the advantageous effect of each embodiment by setting the lower limit value of Conditional Expression (9) to 0.53, 0.55, 0.58, 0.60, 0.63, 0.65 or 0.68.

In the zoom optical system ZL according to each of the first to fourth embodiments, the focusing group GF preferably has negative refractive power, and the following Conditional Expression (10) is preferably satisfied.

0.50<fRw/(−fF)<4.00 (10)
Where,
fRw: focal length of the rear group GR in the wide-angle end state, and
fF: focal length of the focusing group GF.

Conditional Expression (10) defines an appropriate relation between the focal length of the rear group GR in the wide-angle end state and the focal length of the focusing group GF having negative refractive power. When satisfying Conditional Expression (10), the zoom optical system ZL with a small size can excellently correct a variety of aberrations.

When the correspondence value of Conditional Expression (10) is out of the above-described range, it is difficult to correct a variety of aberrations through the zoom optical system ZL with a small size. It is possible to secure the advantageous effect of each embodiment by setting the upper limit value of Conditional Expression (10) to 3.75, 3.50, 3.25, 3.00, 2.75, 2.50, 2.25, 2.00, 1.90, 1.80 or 1.70. Moreover, it is possible to secure the advantageous effect of each embodiment by setting the lower limit value of Conditional Expression (10) to 0.55, 0.60, 0.65, 0.70, 0.75, 0.80, 0.85 or 0.90.

In the zoom optical system ZL according to each of the first to fourth embodiments, the focusing group GF preferably has negative refractive power, and the following conditional expression (11) is preferably satisfied.

0.50<fRt/(−fF)<5.00 (11)
Where,
fRt: focal length of the rear group GR in the telephoto end state, and
fF: focal length of the focusing group GF.

Conditional Expression (11) defines an appropriate relation between the focal length of the rear group GR in the telephoto end state and the focal length of the focusing group GF having negative refractive power. When satisfying Conditional Expression (11), the zoom optical system ZL with a small size can excellently correct a variety of aberrations.

When the correspondence value of Conditional Expression (11) is out of the above-described range, it is difficult to correct a variety of aberrations through the zoom optical system ZL with a small size. It is possible to secure the advantageous effect of each embodiment by setting the upper limit value of Conditional Expression (11) to 4.75, 4.50, 4.25, 4.00, 3.75, 3.50, 3.25, 3.00, 2.75, 2.50 or 2.25. Moreover, it is possible to secure the advantageous effect of each embodiment by setting the lower limit value of Conditional Expression (11) to 0.60, 0.70, 0.75, 0.80, 0.85, 0.90, 0.95, 1.00, 1.05, 1.10 or 1.15.

In the zoom optical system ZL according to each of the first to fourth embodiments, the focusing group GF preferably has positive refractive power and the following Conditional Expression (12) is preferably satisfied.

0.50<ft/fF<10.00 (12)
Where,
ft: focal length of the zoom optical system ZL in the telephoto end state, and
fF: focal length of the focusing group GF.

Conditional Expression (12) defines an appropriate relation between the focal length of the zoom optical system ZL in the telephoto end state and the focal length of the focusing group GF having positive refractive power. When satisfying Conditional Expression (12), the zoom optical system ZL with a small size can reduce variation of spherical aberration, coma aberration, and curvature of field upon focusing on a close distance object.

When the correspondence value of Conditional Expression (12) is out of the above-described range, the moving amount of the focusing group GF is large and thus it is difficult to reduce variation of spherical aberration, coma aberration, and curvature of field upon focusing on a close distance object. It is possible to secure the advantageous effect of each embodiment by setting the upper limit value of Conditional Expression (12) to 8.50, 7.00, 6.00, 5.00, 4.50, 4.00, 3.50, 3.00, 2.75, 2.50, 2.25 or 2.00. Moreover, it is possible to secure the advantageous effect of each embodiment by setting the lower limit value of Conditional Expression (12) to 0.55, 0.60, 0.65, 0.70, 0.75, 0.80, 0.90, 0.95, 1.00, 1.05 or 1.10.

In the zoom optical system ZL according to each of the first to fourth embodiments, the focusing group GF preferably has positive refractive power and the following Conditional Expression (13) is preferably satisfied.

0.30<fw/fF<7.00 (13)
Where,
fw: focal length of the zoom optical system ZL in the wide-angle end state, and
fF: focal length of the focusing group GF.

Conditional Expression (13) defines an appropriate relation between the focal length of the zoom optical system ZL in the wide-angle end state and the focal length of the focusing group GF having positive refractive power. When satisfying Conditional Expression (13), the zoom optical system ZL with a small size can reduce variation of spherical aberration, coma aberration, and curvature of field upon focusing on a close distance object.

When the correspondence value of Conditional Expression (13) is out of the above-described range, the moving amount of the focusing group GF is large and thus it is difficult to reduce variation of spherical aberration, coma aberration, and curvature of field upon focusing on a close distance object. It is possible to secure the advantageous effect of each embodiment by setting the upper limit value of Conditional Expression (13) to 6.00, 5.00, 4.50, 4.00, 3.50, 3.00, 2.75, 2.50, 2.25, 2.00, 1.75, 1.50 or 1.25. Moreover, it is possible to secure the advantageous effect of each embodiment by setting the lower limit value of Conditional Expression (13) to 0.35, 0.40, 0.45, 0.50, 0.55, 0.60 or 0.65.

In the zoom optical system ZL according to each of the first to fourth embodiments, the focusing group GF preferably has positive refractive power and the following Conditional Expression (14) is preferably satisfied.

0.30<(−fFRw)/fF<7.00 (14)
Where,
fFRw: focal length of a lens group of lenses disposed closer to the image side than the focusing group GF in the wide-angle end state, and
fF: focal length of the focusing group GF.

Conditional Expression (14) defines an appropriate relation between the focal length of the lens group (image-side lens group GFR) of lenses disposed closer to the image side than the focusing group GF in the wide-angle end state and the focal length of the focusing group GF having positive refractive power. When satisfying Conditional Expression (14), the zoom optical system ZL with a small size can reduce variation of spherical aberration, coma aberration, and curvature of field upon focusing on a close distance object.

When the correspondence value of Conditional Expression (14) exceeds the upper limit value, the focal length of the focusing group GF is too short for the focal length of the image-side lens group GFR and thus it is difficult to reduce variation of spherical aberration, coma aberration, and curvature of field upon focusing on a close distance object. It is possible to secure the advantageous effect of each embodiment by setting the upper limit value of Conditional Expression (14) to 6.00, 5.00, 4.50, 4.00, 3.50, 3.00, 2.75, 2.50, 2.25, 2.00, 1.75, 1.50 or 1.30.

When the correspondence value of Conditional Expression (14) exceeds the lower limit value, the moving amount of the focusing group GF is large and thus it is difficult to reduce variation of spherical aberration, coma aberration, and curvature of field upon focusing on a close distance object. It is possible to secure the advantageous effect of each embodiment by setting the lower limit value of Conditional Expression (14) to 0.40, 0.50, 0.55, 0.60, 0.65, 0.70, 0.75, 0.80, 0.85, 0.90 or 0.95.

In the zoom optical system ZL according to each of the first to fourth embodiments, the focusing group GF preferably has positive refractive power and the following conditional expression (15) is preferably satisfied.

0.30<(−fFRt)/fF<7.00 (15)
Where,
fFRt: focal length of the lens group of lenses disposed closer to the image side than the focusing group GF in the telephoto end state, and
fF: focal length of the focusing group GF.

Conditional Expression (15) defines an appropriate relation between the focal length of the lens group (image-side lens group GFR) of lenses disposed closer to the image side than the focusing group GF in the telephoto end state and the focal length of the focusing group GF having positive refractive power. When satisfying Conditional Expression (15), the zoom optical system ZL with a small size can reduce variation of spherical aberration, coma aberration, and curvature of field upon focusing on a close distance object.

When the correspondence value of Conditional Expression (15) exceeds the upper limit value, the focal length of the focusing group GF is too short for the focal length of the image-side lens group GFR and thus it is difficult to reduce variation of spherical aberration, coma aberration, and curvature of field upon focusing on a close distance object. It is possible to secure the advantageous effect of each embodiment by setting the upper limit value of Conditional Expression (15) to 6.00, 5.00, 4.50, 4.00, 3.75, 3.50, 3.00, 3.25, 3.00, 2.75, 2.50 or 2.25.

When the correspondence value of Conditional Expression (15) exceeds the lower limit value, the moving amount of the focusing group GF is large and thus it is difficult to reduce variation of spherical aberration, coma aberration, and curvature of field upon focusing on a close distance object. It is possible to secure the advantageous effect of each embodiment by setting the lower limit value of Conditional Expression (15) to 0.40, 0.50, 0.60, 0.70, 0.80, 0.90, 1.00, 1.05, 1.10 or 1.15.

In the zoom optical system ZL according to each of the first to fourth embodiments, the focusing group GF preferably has positive refractive power and the following Conditional Expression (16) is preferably satisfied.

0.20<fRPF/fF<3.00 (16)
Where,
fRPF: focal length of the lens group having positive refractive power and disposed closest to the object side in the at least one lens group of the rear group GR, and
fF: focal length of the focusing group GF.

Conditional Expression (16) defines an appropriate relation between the focal length of the lens group having positive refractive power and disposed closest to the object side in the at least one lens group of the rear group GR and the focal length of the focusing group GF having positive refractive power. When satisfying Conditional Expression (16), the zoom optical system ZL with a small size can reduce variation of spherical aberration, coma aberration, and curvature of field upon focusing on a close distance object.

When the correspondence value of Conditional Expression (16) exceeds the upper limit value, the focal length of the focusing group GF is short and thus it is difficult to reduce variation of spherical aberration, coma aberration, and curvature of field upon focusing on a close distance object. It is possible to secure the advantageous effect of each embodiment by setting the upper limit value of Conditional Expression (16) to 2.75, 2.50, 2.25, 2.00, 1.75, 1.50, 1.25, 1.00, 0.95 or 0.90.

When the correspondence value of Conditional Expression (16) exceeds the lower limit value, the focal length of the lens group having positive refractive power and disposed closest to the object side in the rear group GR is short and thus it is difficult to correct spherical aberration and coma aberration. It is possible to secure the advantageous effect of each embodiment by setting the lower limit value of Conditional Expression (16) to 0.25, 0.30, 0.35, 0.40 or 0.45.

In the zoom optical system ZL according to each of the first to fourth embodiments, the focusing group GF preferably has positive refractive power and the following Conditional Expression (17) is preferably satisfied.

0.15<fRw/fF<4.00 (17)
Where,
fRw: focal length of the rear group GR in the wide-angle end state, and
fF: focal length of the focusing group GF.

Conditional Expression (17) defines an appropriate relation between the focal length of the rear group GR in the wide-angle end state and the focal length of the focusing group GF having positive refractive power. When satisfying Conditional Expression (17), the zoom optical system ZL with a small size can excellently correct a variety of aberrations.

When the correspondence value of Conditional Expression (17) exceeds the upper limit value, it is difficult to correct a variety of aberrations through the zoom optical system ZL with a small size. It is possible to secure the advantageous effect of each embodiment by setting the upper limit value of Conditional Expression (17) to 3.50, 3.00, 2.50, 2.00, 1.75, 1.50, 1.25, 1.15, or 1.00. Moreover, it is possible to secure the advantageous effect of each embodiment by setting the lower limit value of Conditional Expression (17) to 0.20, 0.23, 0.25, 0.28, 0.30, 0.33 or 0.35.

In the zoom optical system ZL according to each of the first to fourth embodiments, the focusing group GF preferably has positive refractive power and the following Conditional Expression (18) is preferably satisfied.

0.15<fRt/fF<5.00 (18)
Where,
fRt: focal length of the rear group GR in the telephoto end state, and
fF: focal length of the focusing group GF.

Conditional Expression (18) defines an appropriate relation between the focal length of the rear group GR in the telephoto end state and the focal length of the focusing group GF having positive refractive power. When satisfying Conditional Expression (18), the zoom optical system ZL with a small size can excellently correct a variety of aberrations.

When the correspondence value of Conditional Expression (18) exceeds the upper limit value, it is difficult to correct a variety of aberrations through the zoom optical system ZL with a small size. It is possible to secure the advantageous effect of each embodiment by setting the upper limit value of Conditional Expression (18) to 4.50, 4.00, 3.75, 3.50, 3.25, 3.00, 2.75, 2.50 or 2.30. Moreover, it is possible to secure the advantageous effect of each embodiment by setting the lower limit value of Conditional Expression (18) to 0.20, 0.25, 0.30, 0.33, 0.35, 0.38, 0.40, 0.43, 0.45 or 0.48.

In the zoom optical system ZL according to each of the first to fourth embodiments, the at least one lens group of the rear group GR is preferably a plurality of lens groups. Accordingly, the zoom optical system ZL can excellently correct curvature of field.

In the zoom optical system ZL according to each of the first to fourth embodiments, the at least one lens group of the rear group GR preferably includes a second lens group G2 having positive refractive power and disposed closest to the object side in the rear group GR. Accordingly, the zoom optical system ZL can excellently correct spherical aberration and coma aberration.

In the zoom optical system ZL according to each of the first to fourth embodiments, the at least one lens group of the rear group GR preferably includes a final lens group GE having positive refractive power and disposed closest to the image side in the rear group GR. Accordingly, the zoom optical system ZL can excellently correct curvature of field.

The zoom optical system ZL according to each of the first to fourth embodiments preferably satisfies the following Conditional Expression (19).

0.10<fRPF/fRPR<0.60 (19)
Where,
fRPF: focal length of the lens group having positive refractive power and disposed closest to the object side in the at least one lens group of the rear group GR, and
fRPR: focal length of a lens group having positive refractive power and disposed closest to the image side in the at least one lens group of the rear group GR.

Conditional Expression (19) defines an appropriate relation between the focal length of the lens group having positive refractive power and disposed closest to the object side in the at least one lens group of the rear group GR and the focal length of the lens group having positive refractive power and disposed closest to the image side in the at least one lens group of the rear group GR. When satisfying Conditional Expression (19), the zoom optical system ZL with a small size can excellently correct curvature of field, spherical aberration, coma aberration, and the like.

When the correspondence value of Conditional Expression (19) exceeds the upper limit value, the focal length of a lens group having positive refractive power and disposed closest to the image side in the rear group GR is short and thus it is difficult to correct curvature of field. It is possible to secure the advantageous effect of each embodiment by setting the upper limit value of Conditional Expression (19) to 0.55, 0.50, 0.48, 0.45, 0.43 or 0.40.

When the correspondence value of Conditional Expression (19) exceeds the lower limit value, the focal length of the lens group having positive refractive power and disposed closest to the object side in the rear group GR is short and thus it is difficult to correct spherical aberration and coma aberration. It is possible to secure the advantageous effect of each embodiment by setting the lower limit value of Conditional Expression (19) to 0.13, 0.15, 0.18 or 0.20.

The zoom optical system ZL according to each of the first to fourth embodiments preferably satisfies the following Conditional Expression (20).

0.05<Bfw/fRPR<0.35 (20)
Where,
Bfw: back focus of the zoom optical system ZL in the wide-angle end state, and
fRPR: focal length of the lens group having positive refractive power and disposed closest to the image side in the at least one lens group of the rear group GR.

Conditional Expression (20) defines an appropriate relation between the back focus of the zoom optical system ZL in the wide-angle end state and the focal length of the lens group having positive refractive power and disposed closest to the image side in the at least one lens group of the rear group GR. When satisfying Conditional Expression (20), the zoom optical system ZL with a small size can excellently correct a variety of aberrations such as curvature of field. Note that the back focus of the zoom optical system ZL in each embodiment is the distance (air equivalent distance) on the optical axis from a lens surface disposed closest to the image side in the zoom optical system ZL to the image surface I upon focusing on infinity.

When the correspondence value of Conditional Expression (20) exceeds the upper limit value, the focal length of the lens group having positive refractive power and disposed closest to the image side in the rear group GR is short and thus it is difficult to correct curvature of field. It is possible to secure the advantageous effect of each embodiment by setting the upper limit value of Conditional Expression (20) to 0.33, 0.30, 0.28, 0.25 or 0.23.

When the correspondence value of Conditional Expression (20) exceeds the lower limit value, the focal length of the lens group having positive refractive power and disposed closest to the image side in the rear group GR is too long and thus it is difficult to sufficiently correct curvature of field. It is possible to secure the advantageous effect of each embodiment by setting the lower limit value of Conditional Expression (20) to 0.06 or 0.08.

In the zoom optical system ZL according to each of the first to fourth embodiments, a lens disposed closest to the object side in the rear group GR is preferably a positive lens. Accordingly, the zoom optical system ZL can excellently correct curvature of field.

The zoom optical system ZL according to each of the first to fourth embodiments preferably comprises an aperture stop disposed between the first lens group G1 and the rear group GR. Accordingly, the zoom optical system ZL can excellently correct coma aberration.

The zoom optical system ZL according to each of the first to fourth embodiments preferably satisfies the following conditional expression (21).

60.00°<2ωw<90.00° (21)
Where,
2ωw: full angle of view of the zoom optical system ZL in the wide-angle end state.

Conditional Expression (21) defines an appropriate range of the full angle of view of the zoom optical system ZL in the wide-angle end state. Conditional Expression (21) is preferably satisfied because a zoom optical system having favorable optical performance with a small size can be obtained. It is possible to secure the advantageous effect of each embodiment by setting the upper limit value of Conditional Expression (21) to 85.00°, 83.00°, 80.00° or 78.00°. It is possible to secure the advantageous effect of each embodiment by setting the lower limit value of Conditional Expression (21) to 63.00°, 65.00°, 68.00° or 70.00°.

The zoom optical system ZL according to each of the first to fourth embodiments preferably satisfies the following Conditional Expression (22).

1.50<(−f1)/fRw<3.00 (22)
Where,
f1: focal length of the first lens group G1, and
fRw: focal length of the rear group GR in the wide-angle end state.

Conditional Expression (22) defines an appropriate relation between the focal length of the first lens group G1 and the focal length of the rear group GR in the wide-angle end state. When satisfying Conditional Expression (22), the zoom optical system ZL with a small size can obtain favorable optical performance in the entire range of zooming.

When the correspondence value of Conditional Expression (22) exceeds the upper limit value, it is difficult to correct spherical aberration and coma aberration. It is possible to secure the advantageous effect of each embodiment by setting the upper limit value of Conditional Expression (22) to 2.95, 2.90, 2.85, 2.80, 2.75 or 2.70.

When the correspondence value of Conditional Expression (22) exceeds the lower limit value, it is difficult to correct spherical aberration and curvature of field. It is possible to secure the advantageous effect of each embodiment by setting the lower limit value of Conditional Expression (22) to 1.55, 1.60, 1.65, 1.70, 1.75 or 1.80.

The zoom optical system ZL according to each of the first to fourth embodiments preferably satisfies the following Conditional Expression (23).

0.50<(−f1)/fRt<2.50 (23)
Where,
f1: focal length of the first lens group G1, and
fRt: focal length of the rear group GR in the telephoto end state.

Conditional Expression (23) defines an appropriate relation between the focal length of the first lens group G1 and the focal length of the rear group GR in the telephoto end state. When satisfying Conditional Expression (23), the zoom optical system ZL with a small size can obtain favorable optical performance in the entire range of zooming.

When the correspondence value of Conditional Expression (23) exceeds the upper limit value, it is difficult to correct spherical aberration and coma aberration. It is possible to secure the advantageous effect of each embodiment by setting the upper limit value of Conditional Expression (23) to 2.40, 2.30, 2.20, 2.10, 2.05 or 2.00.

When the correspondence value of Conditional Expression (23) exceeds the lower limit value, it is difficult to correct spherical aberration and curvature of field. It is possible to secure the advantageous effect of each embodiment by setting the lower limit value of Conditional Expression (23) to 0.55, 0.65, 0.75, 0.85 or 0.90.

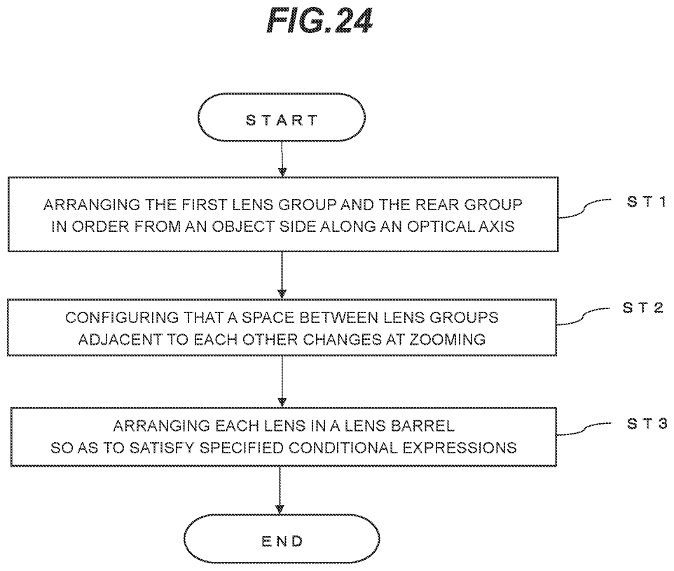

An outline of a method for manufacturing the zoom optical system ZL according to the first embodiment will be described below with reference to FIG. 24. First, the first lens group G1 having negative refractive power and the rear group GR including at least one lens group are disposed in order from the object side along the optical axis (step ST1). Subsequently, the lens groups are configured such that the space between the lens groups adjacent to each other changes at zooming (step ST2). Then, lenses are disposed in a lens barrel such that at least Conditional Expression (1) described above is satisfied (step ST3). According to such a manufacturing method, it is possible to manufacture a zoom optical system having favorable optical performance with a small size.

An outline of a method for manufacturing the zoom optical system ZL according to the second embodiment will be described below. The method for manufacturing the zoom optical system ZL according to the second embodiment is the same as the manufacturing method described above in the first embodiment and thus will be described with reference to FIG. 24 as in the first embodiment. First, the first lens group G1 having negative refractive power and the rear group GR including at least one lens group are disposed in order from the object side along the optical axis (step ST1). Subsequently, the lens groups are configured such that the space between the lens groups adjacent to each other changes at zooming (step ST2). Then, lenses are disposed in a lens barrel such that at least Conditional Expression (2) described above is satisfied (step ST3). According to such a manufacturing method, it is possible to manufacture a zoom optical system having favorable optical performance with a small size.

An outline of a method for manufacturing the zoom optical system ZL according to the third embodiment will be described below. The method for manufacturing the zoom optical system ZL according to the third embodiment is the same as the manufacturing method described above in the first embodiment and thus will be described with reference to FIG. 24 as in the first embodiment. First, the first lens group G1 having negative refractive power and the rear group GR including at least one lens group are disposed in order from the object side along the optical axis (step ST1). Subsequently, the lens groups are configured such that the space between the lens groups adjacent to each other changes at zooming (step ST2). Then, lenses are disposed in a lens barrel such that at least Conditional Expression (3) described above is satisfied (step ST3). According to such a manufacturing method, it is possible to manufacture a zoom optical system having favorable optical performance with a small size.

An outline of a method for manufacturing the zoom optical system ZL according to the fourth embodiment will be described below. The method for manufacturing the zoom optical system ZL according to the fourth embodiment is the same as the manufacturing method described above in the first embodiment and thus will be described with reference to FIG. 24 as in the first embodiment. First, the first lens group G1 having negative refractive power and the rear group GR including at least one lens group are disposed in order from the object side along the optical axis (step ST1). Subsequently, the lens groups are configured such that the space between the lens groups adjacent to each other changes at zooming (step ST2). Then, lenses are disposed in a lens barrel such that at least Conditional Expression (4) described above is satisfied (step ST3). According to such a manufacturing method, it is possible to manufacture a zoom optical system having favorable optical performance with a small size.

### EXAMPLES

The zoom optical system ZL according to an example of each embodiment will be described below with reference to the accompanying drawings. FIGS. 1, 3, 5, 7, 9, 11, 13, 15, 17, 19, and 21 are cross-sectional views showing the configurations and refractive power distributions of the zoom optical systems ZL {ZL (1) to ZL (11)} according to first to eleventh examples. In the cross-sectional views of the zoom optical systems ZL (1) to ZL (11) according to the first to eleventh examples, the moving direction of the focusing group along the optical axis upon focusing on from an infinite distance object to a close distance object is shown with an arrow denoted by “focusing”. In the cross-sectional views of the zoom optical systems ZL (1) to ZL (11) according to the first to eleventh examples, the moving direction of each lens group along the optical axis upon zooming from the wide-angle end state (W) to the telephoto end state (T) is shown with an arrow.

In FIGS. 1, 3, 5, 7, 9, 11, 13, 15, 17, 19, and 21, each lens group is denoted by a combination of a reference sign “G” and a number, and each lens is denoted by a combination of a reference sign “L” and a number. In this case, each lens group or the like is denoted by using a combination of a reference sign and a number independently for each example to prevent complication due to increase in the kinds and magnitudes of reference signs and numbers. Accordingly, the same combination of a reference sign and a number in the examples does not necessarily mean identical components.

Among Tables 1 to 11 below, Table 1 is a table listing various data in the first example, Table 2 is a table listing various data in the second example, Table 3 is a table listing various data in the third example, Table 4 is a table listing various data in the fourth example, Table 5 is a table listing various data in the fifth example, Table 6 is a table listing various data in the sixth example, Table 7 is a table listing various data in the seventh example, Table 8 is a table listing various data in the eighth example, Table 9 is a table listing various data in the ninth example, Table 10 is a table listing various data in the tenth example, and Table 11 is a table listing various data in the eleventh example. In each example, aberration characteristics are calculated for the d-line (wavelength λ=587.6 nm) and the g-line (wavelength λ=435.8 nm).

In each table of [General Data], f represents the focal length of the entire lens system, FNO represents the F number, w represents the half angle of view (in the unit of ° (degrees)), and Y represents the image height. In addition, TL represents a distance as the sum of Bf (back focus) and the distance from the lens surface disposed closest to the object side to the lens surface disposed closest to the image side on the optical axis in each zoom optical system upon focusing on infinity, and Bf represents the distance (air equivalent distance) from the lens surface disposed closest to the image side to the image surface on the optical axis in each zoom optical system upon focusing on infinity. Note that these values are listed for each of the zooming states of the wide-angle end (W) and the telephoto end (T).

In each table of [General Data], the value of fF represents the focal length of the focusing group. The value of fRw represents the focal length of the rear group in the wide-angle end state. The value of fRt represents the focal length of the rear group in the telephoto end state. The value of fFRw represents the focal length of the lens group (image-side lens group) of lenses disposed closer to the image side than the focusing group in the wide-angle end state. The value of fFRt represents the focal length of the lens group (image-side lens group) of lenses disposed closer to the image side than the focusing group in the telephoto end state. The value of fRPF represents the focal length of the lens group having positive refractive power and disposed closest to the object side in the at least one lens group of the rear group. The value of fRPR represents the focal length of the lens group having positive refractive power and disposed closest to the image side in the at least one lens group of the rear group. The value of βRw represents the lateral magnification of the rear group in the wide-angle end state. The value of βRt represents the lateral magnification of the rear group in the telephoto end state.

In each table of [Lens Data], a surface number represents the order of an optical surface from the object side in a direction in which a light beam proceeds, R represents the radius of curvature (defined to have a positive value for a surface having a curvature center positioned on the image side) of an optical surface, D represents a surface distance that is the distance on the optical axis from an optical surface to the next optical surface (or the image surface), nd represents the refractive index of the material of an optical member at the d-line, and νd represents the Abbe number of the material of an optical member with reference to the d-line. The symbol “∞” for the radius of curvature indicates a plane or an opening, and “(aperture stop S)” indicates an aperture stop S. Notation of the refractive index nd of air=1.00000 is omitted. When an optical surface is aspherical, the symbol “*” is attached to the surface number, and the paraxial radius of curvature is listed in the column of the radius R of curvature.

In each table of [Aspherical surface data], the shape of each aspherical surface listed in [Lens Data] is expressed by Expression (A) below. In the expression, X(y) represents a distance (sag amount) in the optical axis direction from a tangent plane at the apex of the aspherical surface to a position on the aspherical surface at a height y, R represents the radius of curvature (paraxial radius of curvature) of a reference spherical surface, K represents a conic constant, and Ai represents the i-th order aspherical coefficient. The notation “E-n” represents “×10⁻ⁿ”. For example, 1.234E-05=1.234×10⁻⁵. Note that the secondary aspherical coefficient A2 is zero, and notation thereof is omitted.

X(y)=(y²/R)/{1+(1−κ×y²/R²)^{1/2}}+A4×y⁴+A6×y⁶+A8×y⁸+A10×y¹⁰ (A)

Each table of [Variable distance data] lists surface distance for a surface number i of the surface distance “Di” in the table of [Lens Data]. The table of [Variable distance data] also lists the surface distance upon focusing on infinity and the surface distance upon focusing on a very short distance object.

Each table of [Lens group data] lists the first surface (surface closest to the object side) and focal length of each lens group.

Unless otherwise stated, the unit “mm” is typically used for all data values such as the focal length f, the radius R of curvature, the surface distance D, and other lengths listed in the tables below, but each optical system can obtain equivalent optical performance when proportionally scaled up or down, and thus the values are not limited to the unit.

The above description of the tables is common to all examples, and any duplicate description is omitted below.

### First Example

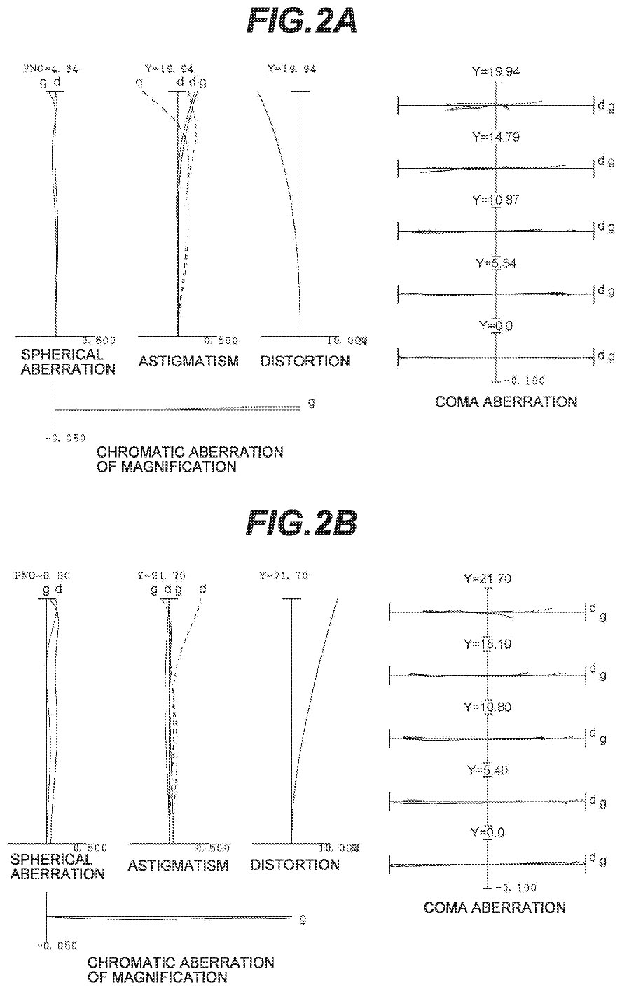

The first example will be described below with reference to FIGS. 1, 2A, 2B and Table 1. FIG. 1 is a diagram showing a lens configuration of the zoom optical system according to the first example. The zoom optical system ZL(1) according to the first example comprises a first lens group G1 having negative refractive power, an aperture stop S, a second lens group G2 having positive refractive power, a third lens group G3 having positive refractive power, and a fourth lens group G4 having positive refractive power, the lens groups being arranged in order from the object side along the optical axis. Upon zooming from the wide-angle end state (W) to the telephoto end state (T), the first lens group G1 temporarily moves to the image side along the optical axis and then moves to the object side, the second lens group G2 and the third lens group G3 move to the object side along the optical axis, and the space between the lens groups adjacent to each other changes. Upon zooming, the aperture stop S moves along the optical axis together with the second lens group G2 and the position of the fourth lens group G4 is fixed relative to the image surface I. Each sign (+) or (−) attached to the reference sign of a lens group represents the refractive power of the lens group, and this notation applies to all examples below as well.

The first lens group G1 includes a cemented lens constituted by a plano-convex positive lens L11 having a flat surface toward the object side and a biconcave negative lens L12, and a biconcave negative lens L13, the lenses being arranged in order from an object side along an optical axis.

The second lens group G2 includes a positive meniscus lens L21 having a convex surface toward the object side, a biconvex positive lens L22, a cemented lens constituted by a positive meniscus lens L23 having a concave surface toward the object side and a negative meniscus lens L24 having a concave surface toward the object side, a positive meniscus lens L25 having a concave surface toward the object side, and a negative meniscus lens L26 having a concave surface toward the object side, the lens being arranged in order from an object side along an optical axis. The positive meniscus lens L21 has aspherical lens surfaces on both sides. The positive meniscus lens L25 has aspherical lens surfaces on both sides. The negative meniscus lens L26 has an aspherical lens surface on the image side.

The third lens group G3 includes a positive meniscus lens L31 having a concave surface toward the object side. The fourth lens group G4 includes a positive meniscus lens L41 having a concave surface toward the object side. The positive meniscus lens L41 has an aspherical lens surface on the image side. The image surface I is disposed on the image side of the fourth lens group G4. In addition, a parallel flat plate PP is disposed between the fourth lens group G4 and the image surface I.

In the present example, the second lens group G2, the third lens group G3, and the fourth lens group G4 serve as the rear group GR having positive refractive power as a whole. The fourth lens group G4 corresponds to the final lens group GE disposed closest to the image side in the rear group GR. The positive meniscus lens L25 and the negative meniscus lens L26 in the second lens group G2 serve as the focusing group GF that moves along the optical axis upon focusing. Upon focusing on from an infinite distance object to a close distance object, the focusing group GF (the positive meniscus lens L25 and the negative meniscus lens L26 in the second lens group G2) moves to the image side along the optical axis. The third lens group G3 (positive meniscus lens L31) and the fourth lens group G4 (positive meniscus lens L41) serve as the image-side lens group GFR of lenses disposed closer to the image side than the focusing group GF.

Table 1 below shows data values of the zoom optical system according to the first example.

TABLE 1
[General Data]

| | |
|---|---|
| Zooming ratio = 1.686 | |
| fF = −13.469 | |
| fRw = 22.428 | fRt = 27.572 |
| fFRw = 27.573 | fFRt = 30.766 |
| fRPF = 19.536 | fRPR = 62.124 |
| βRw = −0.665 | βRt = −1.121 |

| | W | M | T |
|---|---|---|---|
| f | 28.745 | 40.000 | 48.481 |
| FNO | 4.635 | 5.749 | 6.489 |
| ω | 37.870 | 27.025 | 21.831 |
| Y | 19.939 | 21.700 | 21.700 |
| TL | 55.075 | 53.822 | 55.075 |
| Bf | 10.305 | 10.305 | 10.305 |

[Lens Data]

| Surface | | | | |
|---|---|---|---|---|
| Number | R | D | nd | νd |
| 1 | ∞ | 1.99620 | 1.922859 | 20.88 |
| 2 | −61.67336 | 0.87789 | 1.593190 | 67.90 |
| 3 | 94.82844 | 1.52115 | | |
| 4 | −37.67366 | 0.87153 | 1.799520 | 42.09 |
| 5 | 775.23425 | (D5) | | |
| 6 | ∞ | 1.00000 | | (Aperture |
| | | | | Stop S) |
| 7* | 6.74413 | 2.55372 | 1.497103 | 81.56 |
| 8* | 15.34883 | 1.61262 | | |
| 9 | 25.17654 | 2.66678 | 1.593190 | 67.90 |
| 10 | −9.58280 | 0.30884 | | |
| 11 | −12.09204 | 1.97615 | 1.497820 | 82.57 |
| 12 | −6.39708 | 0.80000 | 1.801000 | 34.92 |
| 13 | −41.47880 | (D13) | | |
| 14* | −15.65263 | 1.08809 | 1.693500 | 53.20 |
| 15* | −13.65939 | 4.06569 | | |
| 16 | −6.58010 | 1.00000 | 1.593190 | 67.90 |
| 17* | −81.14295 | (D17) | | |
| 18 | −230.52245 | 2.89238 | 1.922859 | 20.88 |
| 19 | −36.62793 | (D19) | | |
| 20 | −40.68082 | 2.24629 | 1.768015 | 49.24 |
| 21* | −22.48518 | 8.25000 | | |
| 22 | ∞ | 1.60000 | 1.516800 | 63.88 |
| 23 | ∞ | 1.00000 | | |

[Aspherical Surface Data]

7th Surface
κ = 1.0000, A4 = 1.88915E−04, A6 = 4.93302E−06,
A8 = 3.01855E−07, A10 = 0.00000E+00
8th Surface
κ = 1.0000, A4 = 7.66909E−04, A6 = 1.32765E−05,
A8 = 9.83562E−07, A10 = 0.00000E+00
14th Surface
κ = 1.0000, A4 = 9.45995E−04, A6 = 1.82284E−05,
A8 = −1.90524E−07, A10 = 0.00000E+00
15th Surface
κ = 1.0000, A4−8.64798E−04, A6 = 1.59927E−05,
A8 = 5.50227E−08, A10 = 0.00000E+00
17th Surface
κ = 1.0000, A4 = −1.24954E−04, A6−8.78929E−07,
A8 = −7.97530E−09, A10 = 0.00000E+00
21st Surface
κ = 1.0000, A4 = 3.11712E−05, A6 = 1.30785E−08,
A8 = 3.17570E−11, A10 = 0.00000E+00

[Variable Distance Data]

| | | |
|---|---|---|
| W | M | T |

Upon focusing on infinity

| | | | |
|---|---|---|---|
| Focal length | 28.745 | 40.000 | 48.481 |
| Distance | ∞ | ∞ | ∞ |
| D5 | 12.279 | 4.849 | 1.513 |
| D13 | 1.029 | 1.029 | 1.029 |
| D17 | 2.985 | 2.943 | 2.795 |
| D19 | 1.000 | 7.219 | 11.955 |

Upon focusing on a very short distance object

| | | | |
|---|---|---|---|
| Magnification | −0.113 | −0.164 | −0.206 |
| Distance | 244.380 | 245.633 | 244.380 |
| D5 | 12.279 | 4.849 | 1.513 |
| D13 | 2.335 | 2.925 | 3.381 |
| D17 | 1.679 | 1.046 | 0.443 |
| D19 | 1.000 | 7.219 | 11.955 |

[Lens Group Data]

| | First | Focal |
|---|---|---|
| Group | surface | length |
| G1 | 1 | −43.251 |
| G2 | 7 | 19.536 |
| G3 | 18 | 46.852 |
| G4 | 20 | 62.124 |

FIG. 2A is a variety of aberration diagrams of the zoom optical system according to the first example upon focusing on infinity in the wide-angle end state. FIG. 2B is a variety of aberration diagrams of the zoom optical system according to the first example upon focusing on infinity in the telephoto end state. In each aberration diagram, FNO represents the F-number, and Y represents the image height. Note that each spherical aberration diagram indicates the value of the F-number corresponding to the maximum diameter, each astigmatism diagram and each distortion diagram indicate the maximum value of the image height, and each coma aberration diagram indicates values of the image height. In the diagrams, d represents the d-line (wavelength λ=587.6 nm), and g represents the g-line (wavelength λ=435.8 nm). In each astigmatism diagram, a solid line represents a sagittal image surface, and a dashed line represents a meridional image surface. Note that the same reference signs as in the present example are also used in the aberration diagrams of each example described below, and duplicate description thereof is omitted.

From the variety of aberration diagrams, it can be understood that the zoom optical system according to the first example has a variety of aberrations excellently corrected in both the wide-angle end state and the telephoto end state and has excellent imaging performance.

### Second Example

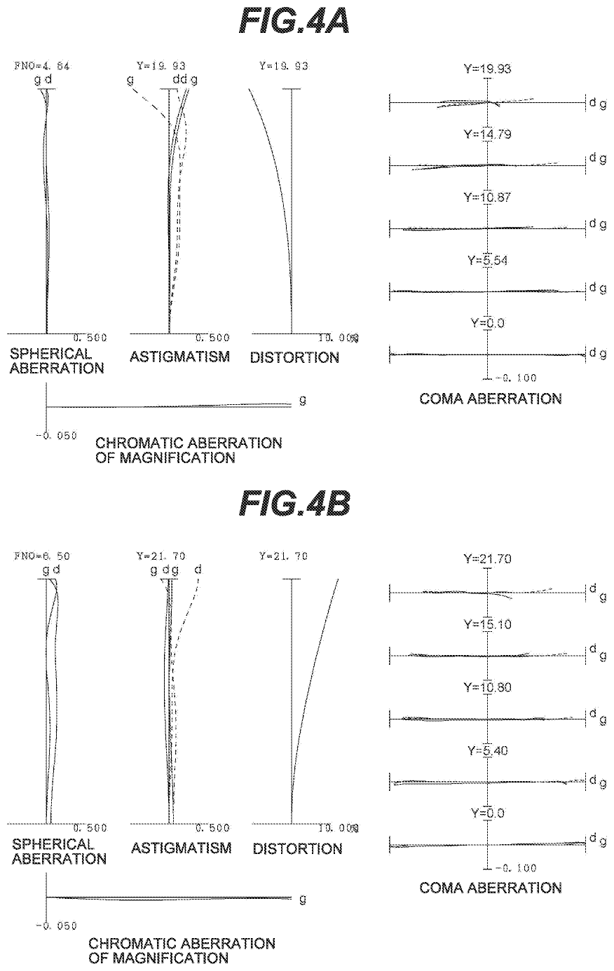

The second example will be described below with reference to FIGS. 3, 4A, 4B and Table 2. FIG. 3 is a diagram showing a lens configuration of the zoom optical system according to the second example. The zoom optical system according to the second example ZL(2) comprises a first lens group G1 having negative refractive power, an aperture stop S, a second lens group G2 having positive refractive power, a third lens group G3 having positive refractive power, and a fourth lens group G4 having positive refractive power, the lens groups being arranged in order from an object side along an optical axis. Upon zooming from the wide-angle end state (W) to the telephoto end state (T), the first lens group G1 temporarily moves to the image side along the optical axis and then moves to the object side, the second lens group G2 and the third lens group G3 move to the object side along the optical axis, and the space between the lens groups adjacent to each other changes. Upon zooming, the aperture stop S moves along the optical axis together with the second lens group G2 and the position of the fourth lens group G4 is fixed relative to the image surface I.

In the second example, the first lens group G1, the second lens group G2, the third lens group G3, and the fourth lens group G4 are configured in the same manner as in the first example and thus denoted by the same reference signs as in the first example, and detailed description of the lenses is omitted. In the present example, the second lens group G2, the third lens group G3, and the fourth lens group G4 serve as the rear group GR having positive refractive power as a whole. The fourth lens group G4 corresponds to the final lens group GE disposed closest to the image side in the rear group GR. The positive meniscus lens L25 and the negative meniscus lens L26 in the second lens group G2 serve as the focusing group GF that moves along the optical axis upon focusing. Upon focusing on from an infinite distance object to a close distance object, the focusing group GF (the positive meniscus lens L25 and the negative meniscus lens L26 in the second lens group G2) moves to the image side along the optical axis. The third lens group G3 (positive meniscus lens L31) and the fourth lens group G4 (positive meniscus lens L41) serve as the image-side lens group GFR of lenses disposed closer to the image side than the focusing group GF.

Table 2 below shows data values of the zoom optical system according to the second example.

TABLE 2
[General Data]

| | |
|---|---|
| Zooming ratio = 1.687 | |
| fF = −13.491 | |
| fRw = 22.454 | fRt = 27.757 |
| fFRw = 27.409 | fFRt = 30.589 |
| fRPF = 15.676 | fRPR = 61.423 |
| βRw = −0.662 | βRt = −1.116 |

| | W | M | T |
|---|---|---|---|
| f | 28.745 | 40.001 | 48.482 |
| FNO | 4.635 | 5.736 | 6.489 |
| ω | 37.866 | 27.032 | 21.801 |
| Y | 19.928 | 21.700 | 21.700 |
| TL | 55.064 | 53.621 | 55.064 |
| Bf | 10.305 | 10.485 | 10.305 |

[Lens Data]

| Surface | | | | |
|---|---|---|---|---|
| Number | R | D | nd | νd |
| 1 | ∞ | 1.99725 | 1.922859 | 20.88 |
| 2 | −61.58859 | 0.87546 | 1.593190 | 67.90 |
| 3 | 100.28735 | 1.49398 | | |
| 4 | −37.97558 | 0.87137 | 1.799520 | 42.09 |
| 5 | 550.89033 | (D5) | | |
| 6 | ∞ | 1.00000 | | (Aperture |
| | | | | Stop S) |
| 7* | 6.73949 | 2.54345 | 1.497103 | 81.56 |
| 8* | 15.13316 | 1.62404 | | |
| 9 | 24.63480 | 2.67430 | 1.593190 | 67.90 |
| 10 | −9.61747 | 0.31183 | | |
| 11 | −12.16080 | 1.97765 | 1.497820 | 82.57 |
| 12 | −6.40689 | 0.80000 | 1.801000 | 34.92 |
| 13 | −42.72321 | (D13) | | |
| 14* | −15.59490 | 1.08938 | 1.693500 | 53.20 |
| 15* | −13.62652 | 4.08182 | | |
| 16 | −6.58583 | 1.00037 | 1.593190 | 67.90 |
| 17* | −80.21449 | (D17) | | |
| 18 | −218.94268 | 2.88641 | 1.922859 | 20.88 |
| 19 | −36.26331 | (D19) | | |
| 20 | −40.30806 | 2.26539 | 1.768015 | 49.24 |
| 21* | −22.26647 | 8.25000 | | |
| 22 | ∞ | 1.60000 | 1.516800 | 63.88 |
| 23 | ∞ | 1.00000 | | |

[Aspherical Surface Data]

7th Surface
κ = 1.0000, A4 = 1.92075E−04, A6 = 4.79807E−06,
A8 = 3.11755E−07, A10 = 0.00000E+00
8th Surface
κ = 1.0000, A4 = 7.70170E−04, A6 = 1.30465E−05,
A8 = 1.00763E−06, A10 = 0.00000E+00
14th Surface
κ = 1.0000, A4 = 9.21586E−04, A6 = 1.86210E−05,
A8 = −1.96584E−07, A10 = 0.00000E+00
15th Surface
κ = 1.0000, A4 = 8.40862E−04, A6 = 1.62428E−05,
A8 = 4.53775E−08, A10 = 0.00000E+00
17th Surface
κ = 1.0000, A4 = −1.23223E−04, A6 = 8.46946E−07,
A8 = −7.60366E−09, A10 = 0.00000E+00
21st Surface
κ = 1.0000, A4 = 3.16515E−05, A6 = 1.26787E−08,
A8 = 3.70654E−11, A10 = 0.00000E+00

[Variable Distance Data]

| | | |
|---|---|---|
| W | M | T |

Upon focusing on infinity

| | | | |
|---|---|---|---|
| Focal length | 28.745 | 40.001 | 48.482 |
| Distance | ∞ | ∞ | ∞ |
| D5 | 12.308 | 4.752 | 1.518 |
| D13 | 1.041 | 1.041 | 1.041 |
| D17 | 2.917 | 2.726 | 2.818 |
| D19 | 1.000 | 7.125 | 11.889 |

Upon focusing on a very short distance object

| | | | |
|---|---|---|---|
| Magnification | −0.113 | −0.164 | −0.206 |
| Distance | 244.391 | 245.833 | 244.391 |
| D5 | 12.308 | 4.752 | 1.518 |
| D13 | 2.359 | 2.966 | 3.415 |
| D17 | 1.599 | 0.801 | 0.444 |
| D19 | 1.000 | 7.125 | 11.889 |

[Lens Group Data]

| | First | Focal |
|---|---|---|
| Group | surface | length |
| G1 | 1 | −43.446 |
| G2 | 7 | 19.566 |
| G3 | 18 | 46.740 |
| G4 | 20 | 61.423 |

FIG. 4A is a variety of aberration diagrams of the zoom optical system according to the second example upon focusing on infinity in the wide-angle end state. FIG. 4B is a variety of aberration diagrams of the zoom optical system according to the second example upon focusing on infinity in the telephoto end state. From the variety of aberration diagrams, it can be understood that the zoom optical system according to the second example has a variety of aberrations excellently corrected in both the wide-angle end state and the telephoto end state and has excellent imaging performance.

### Third Example

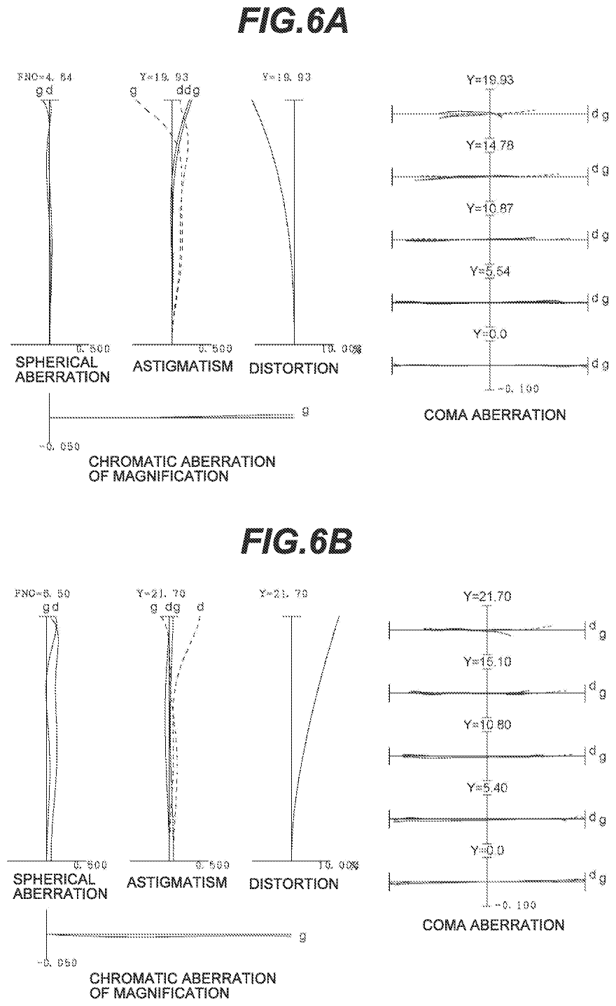

The third example will be described below with reference to FIGS. 5, 6A, 6B and Table 3. FIG. 5 is a diagram showing a lens configuration of the zoom optical system according to the third example. The zoom optical system according to the third example ZL(3) comprises a first lens group G1 having negative refractive power, an aperture stop S, a second lens group G2 having positive refractive power, a third lens group G3 having negative refractive power, a fourth lens group G4 having positive refractive power, and a fifth lens group G5 having positive refractive power, the lens groups being arranged in order from an object side along an optical axis. Upon zooming from the wide-angle end state (W) to the telephoto end state (T), the first lens group G1 temporarily moves to the image side along the optical axis and then moves to the object side, the second lens group G2, the third lens group G3, and the fourth lens group G4 move to the object side along the optical axis, and the space between the lens groups adjacent to each other changes. Upon zooming, the aperture stop S moves along the optical axis together with the second lens group G2 and the position of the fifth lens group G5 is fixed relative to the image surface I.

The first lens group G1 includes a cemented lens constituted by a plano-convex positive lens L11 having a flat surface toward the object side and a biconcave negative lens L12, and a biconcave negative lens L13, the lenses being arranged in order from an object side along an optical axis.

The second lens group G2 includes a positive meniscus lens L21 having a convex surface toward the object side, a biconvex positive lens L22, and a cemented lens constituted by a positive meniscus lens L23 having a concave surface toward the object side and a negative meniscus lens L24 having a concave surface toward the object side, the lenses being arranged in order from an object side along an optical axis. The positive meniscus lens L21 has aspherical lens surfaces on both sides.

The third lens group G3 includes a positive meniscus lens L31 having a concave surface toward the object side, and a negative meniscus lens L32 having a concave surface toward the object side, the lenses being arranged in order from an object side along an optical axis. The positive meniscus lens L31 has aspherical lens surfaces on both sides. The negative meniscus lens L32 has an aspherical lens surface on the image side.

The fourth lens group G4 includes a positive meniscus lens L41 having a concave surface toward the object side. The fifth lens group G5 includes a positive meniscus lens L51 having a concave surface toward the object side. The positive meniscus lens L51 has an aspherical lens surface on the image side. The image surface I is disposed on the image side of the fifth lens group G5. In addition, a parallel flat plate PP is disposed between the fifth lens group G5 and the image surface I.

In the present example, the second lens group G2, the third lens group G3, the fourth lens group G4, and the fifth lens group G5 serve as the rear group GR having positive refractive power as a whole. The fifth lens group G5 corresponds to the final lens group GE disposed closest to the image side in the rear group GR. The entire third lens group G3 serves as the focusing group GF that moves along the optical axis upon focusing. Upon focusing on from an infinite distance object to a close distance object, the focusing group GF (entire third lens group G3) moves to the image side along the optical axis. The fourth lens group G4 (positive meniscus lens L41) and the fifth lens group G5 (positive meniscus lens L51) serve as the image-side lens group GFR of lenses disposed closer to the image side than the focusing group GF.

Table 3 below shows data values of the zoom optical system according to the third example.

TABLE 3
[General Data]

| | |
|---|---|
| Zooming ratio = 1.686 | |
| fF = −13.427 | |
| fRw = 22.402 | fRt = 27.702 |
| fFRw = 27.256 | fFRt = 30.400 |
| FRPF = 15.664 | fRPR = 60.598 |
| βRw = −0.666 | βRt = −1.123 |

| | W | M | T |
|---|---|---|---|
| f | 28.754 | 40.001 | 48.489 |
| FNO | 4.635 | 5.731 | 6.489 |
| ω | 37.861 | 26.969 | 21.751 |
| Y | 19.930 | 21.700 | 21.700 |
| TL | 55.048 | 53.459 | 55.048 |
| Bf | 10.305 | 10.305 | 10.305 |

[Lens Data]

| Surface | | | | |
|---|---|---|---|---|
| Number | R | D | nd | νd |
| 1 | ∞ | 2.00818 | 1.922859 | 20.88 |
| 2 | −61.03131 | 0.87438 | 1.593190 | 67.90 |
| 3 | 101.77694 | 1.48276 | | |
| 4 | −38.23636 | 0.87484 | 1.799520 | 42.09 |
| 5 | 424.54741 | (D5) | | |
| 6 | ∞ | 1.00000 | | (Aperture |
| | | | | Stop S) |
| 7* | 6.75681 | 2.55201 | 1.497103 | 81.56 |
| 8* | 15.38664 | 1.63500 | | |
| 9 | 25.27764 | 2.65716 | 1.593190 | 67.90 |
| 10 | −9.63773 | 0.31417 | | |
| 11 | −12.22612 | 1.96902 | 1.497820 | 82.57 |
| 12 | −6.43133 | 0.80000 | 1.801000 | 34.92 |
| 13 | −42.16168 | (D13) | | |
| 14* | −15.65543 | 1.08329 | 1.693500 | 53.20 |
| 15* | −13.76558 | 4.17510 | | |
| 16 | −6.61113 | 1.00000 | 1.593190 | 67.90 |
| 17* | −83.29031 | (D17) | | |
| 18 | −259.59884 | 2.89709 | 1.922859 | 20.88 |
| 19 | −37.19930 | (D19) | | |
| 20 | −41.30813 | 2.25294 | 1.768015 | 49.24 |
| 21* | −22.40267 | 8.25000 | | |
| 22 | ∞ | 1.60000 | 1.516800 | 63.88 |
| 23 | ∞ | 1.00000 | | |

[Aspherical Surface Data]

7th Surface
κ = 1.0000, A4 = 1.92524E−04, A6 = 4.65523E−06,
A8 = 3.21615E−07, A10 = 0.00000E+00
8th Surface
κ = 1.0000, A4 = 7.70473E−04, A6 = 1.27785E−05,
A8 = 1.01681E−06, A10 = 0.00000E+00
14th Surface
κ = 1.0000, A4 = 9.42593E−04, A6 = 1.73477E−05,
A8 = −1.86967E−07, A10−0.00000E+00
15th Surface
κ = 1.0000, A4 = 8.62927E−04, A6 = 1.54043E−05,
A8 = 3.94933E−08, A10 = 0.00000E+00
17th Surface
κ = 1.0000, A4 = −1.27386E−04, A6 = 8.72918E−07,
A8 = −7.68623E−09, A10 = 0.00000E+00
21st Surface
κ = 1.0000, A4 = 3.23926E−05, A6 = 1.22601E−08,
A8 = 3.65636E−11, A10 = 0.00000E+00

[Variable Distance Data]

| | | |
|---|---|---|
| W | M | T |

Upon focusing on infinity

| | | | |
|---|---|---|---|
| Focal length | 28.754 | 40.001 | 48.489 |
| Distance | ∞ | ∞ | ∞ |
| D5 | 12.261 | 4.701 | 1.524 |
| D13 | 1.009 | 1.111 | 1.069 |
| D17 | 2.898 | 2.781 | 2.821 |
| D19 | 1.000 | 6.986 | 11.754 |

Upon focusing on a very short distance object

| | | | |
|---|---|---|---|
| Magnification | −0.114 | −0.164 | −0.206 |
| Distance | 244.407 | 245.996 | 244.407 |
| D5 | 12.261 | 4.701 | 1.524 |
| D13 | 2.325 | 3.046 | 3.447 |
| D17 | 1.582 | 0.846 | 0.443 |
| D19 | 1.000 | 6.986 | 11.754 |

[Lens Group Data]

| | First | Focal |
|---|---|---|
| Group | surface | length |
| G1 | 1 | −43.162 |
| G2 | 7 | 15.664 |
| G3 | 14 | −13.427 |
| G4 | 18 | 46.759 |
| G5 | 20 | 60.598 |

FIG. 6A is a variety of aberration diagrams of the zoom optical system according to the third example upon focusing on infinity in the wide-angle end state. FIG. 6B is a variety of aberration diagrams of the zoom optical system according to the third example upon focusing on infinity in the telephoto end state. From the variety of aberration diagrams, it can be understood that the zoom optical system according to the third example has a variety of aberrations excellently corrected in both the wide-angle end state and the telephoto end state and has excellent imaging performance.

### Fourth Example

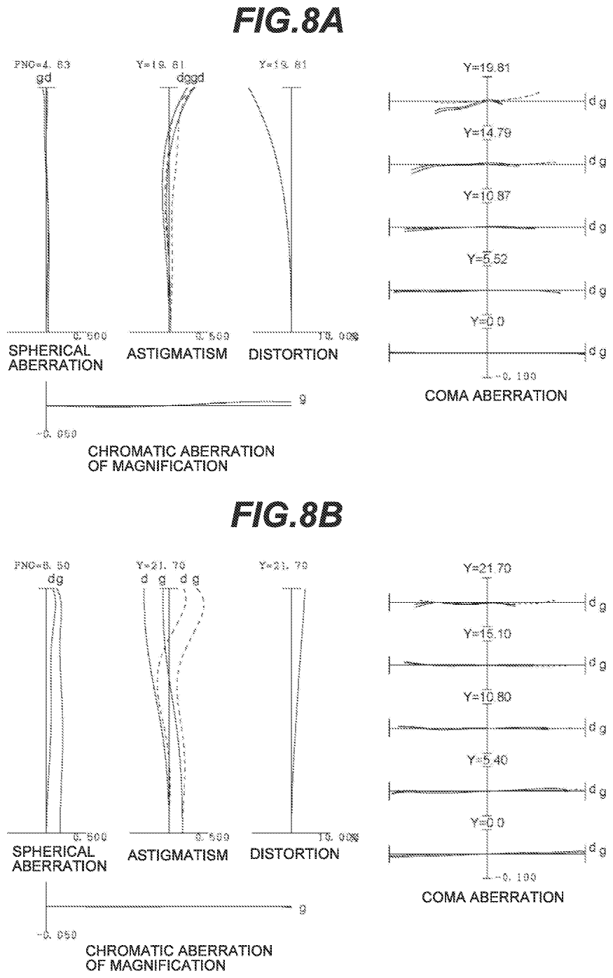

The fourth example will be described below with reference to FIGS. 7, 8A, 8B and Table 4. FIG. 7 is a diagram showing a lens configuration of the zoom optical system according to the fourth example. The zoom optical system according to the fourth example ZL(4) comprises a first lens group G1 having negative refractive power, an aperture stop S, a second lens group G2 having positive refractive power, a third lens group G3 having negative refractive power, and a fourth lens group G4 having positive refractive power, the lens groups being arranged in order from an object side along an optical axis. Upon zooming from the wide-angle end state (W) to the telephoto end state (T), the first lens group G1 temporarily moves to the image side along the optical axis and then moves to the object side, the second lens group G2 and the third lens group G3 move to the object side along the optical axis, and the space between the lens groups adjacent to each other changes. Upon zooming, the aperture stop S moves along the optical axis together with the second lens group G2 and the position of the fourth lens group G4 is fixed relative to the image surface I.

The first lens group G1 includes a cemented lens constituted by a positive meniscus lens L11 having a concave surface toward the object side and a biconcave negative lens L12, and a negative meniscus lens L13 having a concave surface toward the object side, the lenses being arranged in order from an object side along an optical axis.

The second lens group G2 includes a biconvex positive lens L21, a negative meniscus lens L22 having a convex surface toward the object side, and a positive meniscus lens L23 having a convex surface toward the object side, the lenses being arranged in order from an object side along an optical axis. The positive lens L21 has aspherical lens surfaces on both sides. The positive meniscus lens L23 has aspherical lens surfaces on both sides.

The third lens group G3 includes a negative meniscus lens L31 having a convex surface toward the object side, and a negative meniscus lens L32 having a concave surface toward the object side, the lenses being arranged in order from an object side along an optical axis. The negative meniscus lens L31 has an aspherical lens surface on the image side. The negative meniscus lens L32 has aspherical lens surfaces on both sides.

The fourth lens group G4 includes a positive meniscus lens L41 having a concave surface toward the object side. The positive meniscus lens L41 has an aspherical lens surface on the image side. The image surface I is disposed on the image side of the fourth lens group G4. In addition, a parallel flat plate PP is disposed between the fourth lens group G4 and the image surface I.

In the present example, the second lens group G2, the third lens group G3, and the fourth lens group G4 serve as the rear group GR having positive refractive power as a whole. The fourth lens group G4 corresponds to the final lens group GE disposed closest to the image side in the rear group GR. The entire third lens group G3 serves as the focusing group GF that moves along the optical axis upon focusing. Upon focusing on from an infinite distance object to a close distance object, the focusing group GF (entire third lens group G3) moves to the image side along the optical axis. The fourth lens group G4 (positive meniscus lens L41) serves as the image-side lens group GFR of lenses disposed closer to the image side than the focusing group GF.

Table 4 below shows data values of the zoom optical system according to the fourth example.

(Table 4)

TABLE 4
[General Data]

| | |
|---|---|
| Zooming ratio = 1.687 | |
| fF = −23.773 | |
| fRw = 23.002 | fRt = 30.777 |
| fFRw = 50.145 | fFRt = 50.145 |
| fRPF = 17.295 | fRPR = 50.145 |
| βRw = −0.628 | βRt = −1.059 |

| | W | M | T |
|---|---|---|---|
| f | 28.744 | 40.000 | 48.486 |
| FNO | 4.635 | 5.719 | 6.489 |
| ω | 37.740 | 28.080 | 23.384 |
| Y | 19.814 | 21.700 | 21.700 |
| TL | 53.764 | 52.719 | 53.764 |
| Bf | 17.555 | 17.915 | 17.555 |

[Lens Data]

| Surface | | | | |
|---|---|---|---|---|
| Number | R | D | nd | νd |
| 1 | −74.97806 | 1.57056 | 1.922859 | 20.88 |
| 2 | −43.63293 | 0.88324 | 1.593190 | 67.90 |
| 3 | 225.85772 | 1.21996 | | |
| 4 | −40.81390 | 0.88014 | 1.593190 | 67.90 |
| 5 | −1801.45150 | (D5) | | |
| 6 | ∞ | 1.00000 | | (Aperture |
| | | | | Stop S) |
| 7* | 7.78171 | 3.28821 | 1.497103 | 81.56 |
| 8* | −39.66691 | 0.10000 | | |
| 9 | 9.42082 | 0.80000 | 1.902000 | 25.26 |
| 10 | 6.67111 | 1.59048 | | |
| 11* | 29.89210 | 1.17255 | 1.592014 | 67.02 |
| 12* | 64.12762 | (D12) | | |
| 13 | 14.07861 | 0.75819 | 1.497103 | 81.56 |
| 14* | 11.49932 | 7.98047 | | |
| 15* | −10.97492 | 0.99994 | 1.497103 | 81.56 |
| 16* | −43.99636 | (D16) | | |
| 17 | −41.88288 | 5.52332 | 1.882023 | 37.22 |
| 18* | −22.84142 | 8.25000 | | |
| 19 | ∞ | 1.60000 | 1.516800 | 63.88 |
| 20 | ∞ | 1.00000 | | |

[Aspherical Surface Data]

7th Surface
κ = 1.0000, A4 = −6.94600E−05, A6 = 3.33392E−06,
A8 = −6.22219E−08, A10 = 0.00000E+00
8th Surface
κ = 1.0000, A4 = 7.91449E−04, A6 = −9.22475E−06,
A8 = −2.04863E−08, A10 = 0.00000E+00
11th Surface
κ = 1.0000, A4 = 2.22039E−03, A6 = −1.38926E−05,
A8 = 0.00000E+00, A10 = 0.00000E+00
12th Surface
κ = 1.0000, A4 = 1.75015E−03, A6 = 6.88355E−06,
A8 = 0.00000E+00, A10 = 0.00000E+00
14th Surface
κ = 1.0000, A4 = −6.73272E−05, A6 = 3.02052E−07,
A8 = 0.00000E+00, A10−0.00000E+00
15th Surface
κ = 1.0000, A4 = −9.05362E−05, A6 = −5.77549E−07,
A8 = −2.18840E−08, A10 = 0.00000E+00
16th Surface
κ = 1.0000, A4 = −5.42555E−05, A6 = −4.40579E−07,
A8 = 4.88714E−10, A10 = 0.00000E+00
18th Surface
κ = 1.0000, A4 = 9.49522E−06, A6 = −1.26832E−08,
A8 = 4.82544E−11, A10 = 0.00000E+00

[Variable Distance Data]

| | | |
|---|---|---|
| W | M | T |

Upon focusing on infinity

| | | | |
|---|---|---|---|
| Focal length | 28.744 | 40.000 | 48.486 |
| Distance | ∞ | ∞ | ∞ |
| D5 | 12.155 | 4.837 | 1.500 |
| D12 | 0.831 | 0.500 | 0.500 |
| D16 | 2.707 | 8.951 | 13.692 |

Upon focusing on a very short distance object

| | | | |
|---|---|---|---|
| Magnification | −0.112 | −0.161 | −0.200 |
| Distance | 245.691 | 246.736 | 245.691 |
| D5 | 12.155 | 4.837 | 1.500 |
| D12 | 3.014 | 3.465 | 4.074 |
| D16 | 0.523 | 5.986 | 10.118 |

[Lens Group Data]

| | First | Focal |
|---|---|---|
| Group | surface | length |
| G1 | 1 | −45.779 |
| G2 | 7 | 17.295 |
| G3 | 13 | −23.773 |
| G4 | 17 | 50.145 |

FIG. 8A is a variety of aberration diagrams of the zoom optical system according to the fourth example upon focusing on infinity in the wide-angle end state. FIG. 8B is a variety of aberration diagrams of the zoom optical system according to the fourth example upon focusing on infinity in the telephoto end state. From the variety of aberration diagrams, it can be understood that the zoom optical system according to the fourth example has a variety of aberrations excellently corrected in both the wide-angle end state and the telephoto end state and has excellent imaging performance.

### Fifth Example

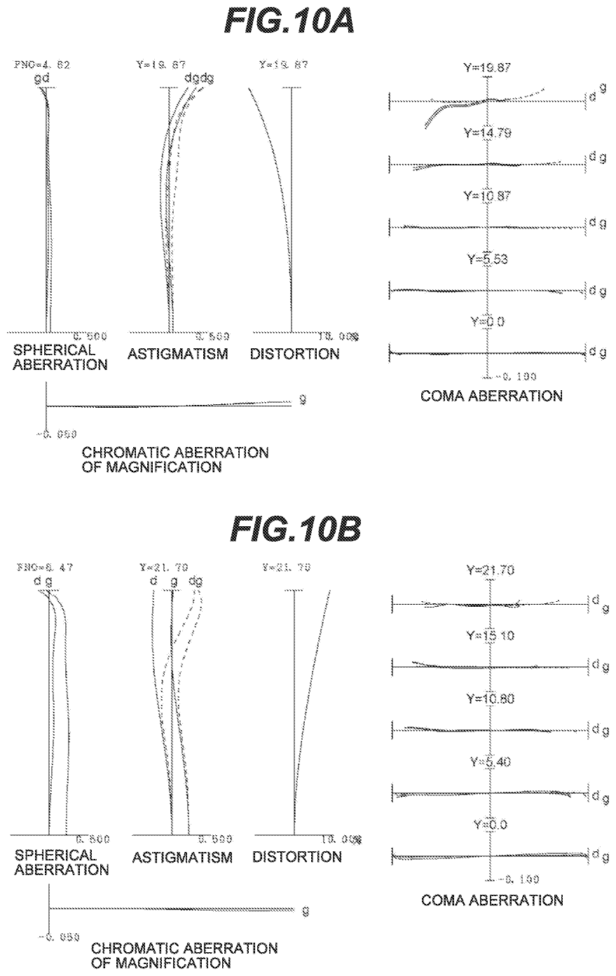

The fifth example will be described below with reference to FIGS. 9, 10A, 10B and Table 5. FIG. 9 is a diagram showing a lens configuration of the zoom optical system according to the fifth example. The zoom optical system according to the fifth example ZL(5) comprises a first lens group G1 having negative refractive power, an aperture stop S, a second lens group G2 having positive refractive power, a third lens group G3 having negative refractive power, a fourth lens group G4 having positive refractive power, and a fifth lens group G5 having positive refractive power, the lens groups being arranged in order from an object side along an optical axis. Upon zooming from the wide-angle end state (W) to the telephoto end state (T), the first lens group G1 temporarily moves to the image side along the optical axis and then moves to the object side, the second lens group G2 and the third lens group G3 move to the object side along the optical axis, the fourth lens group G4 temporarily moves to the object side along the optical axis and then moves to the image side, and the space between the lens groups adjacent to each other changes. Upon zooming, the aperture stop S moves along the optical axis together with the second lens group G2 and the position of the fifth lens group G5 is fixed relative to the image surface I.

The first lens group G1 includes a cemented lens constituted by a positive meniscus lens L11 having a concave surface toward the object side and a biconcave negative lens L12, and a negative meniscus lens L13 having a concave surface toward the object side, the lenses being arranged in order from an object side along an optical axis.

The second lens group G2 includes a biconvex positive lens L21, a negative meniscus lens L22 having a convex surface toward the object side, and a positive meniscus lens L23 having a convex surface toward the object side, the lenses being arranged in order from an object side along an optical axis. The positive lens L21 has aspherical lens surfaces on both sides. The positive meniscus lens L23 has aspherical lens surfaces on both sides.

The third lens group G3 includes a biconvex positive lens L31, and a negative meniscus lens L32 having a concave surface toward the object side, the lenses being arranged in order from an object side along an optical axis. The positive lens L31 has an aspherical lens surface on the image side. The negative meniscus lens L32 has aspherical lens surfaces on both sides.

The fourth lens group G4 includes a positive meniscus lens L41 having a concave surface toward the object side. The positive meniscus lens L41 has an aspherical lens surface on the image side.

The fifth lens group G5 includes a positive meniscus lens L51 having a concave surface toward the object side. The image surface I is disposed on the image side of the fifth lens group G5. In addition, a parallel flat plate PP is disposed between the fifth lens group G5 and the image surface I.

In the present example, the second lens group G2, the third lens group G3, the fourth lens group G4, and the fifth lens group G5 serve as the rear group GR having positive refractive power as a whole. The fifth lens group G5 corresponds to the final lens group GE disposed closest to the image side in the rear group GR. The entire third lens group G3 serves as the focusing group GF that moves along the optical axis upon focusing. Upon focusing on from an infinite distance object to a close distance object, the focusing group GF (entire third lens group G3) moves to the image side along the optical axis. The fourth lens group G4 (positive meniscus lens L41) and the fifth lens group G5 (positive meniscus lens L51) serve as the image-side lens group GFR of lenses disposed closer to the image side than the focusing group GF.

Table 5 below shows data values of the zoom optical system according to the fifth example.

TABLE 5
[General Data]

| | |
|---|---|
| Zooming ratio = 1.687 | |
| fF = −23.557 | |
| fRw = 22.006 | fRt = 27.853 |
| fFRw = 56.322 | fFRt = 56.322 |
| fRPF = 16.507 | fRPR = 72.338 |
| βRw = −0.711 | βRt = −1.200 |

| | W | M | T |
|---|---|---|---|
| f | 28.736 | 39.996 | 48.484 |
| FNO | 4.635 | 5.707 | 6.489 |
| ω | 37.834 | 27.338 | 22.307 |
| Y | 19.873 | 21.700 | 21.700 |
| TL | 53.158 | 52.117 | 53.446 |
| Bf | 10.305 | 10.499 | 10.305 |

[Lens Data]

| Surface | | | | |
|---|---|---|---|---|
| Number | R | D | nd | νd |
| 1 | −78.94193 | 1.72137 | 1.922859 | 20.88 |
| 2 | −40.22624 | 0.88791 | 1.593190 | 67.90 |
| 3 | 214.46025 | 1.47635 | | |
| 4 | −31.48425 | 0.88376 | 1.593190 | 67.90 |
| 5 | −877.76237 | (D5) | | |
| 6 | ∞ | 1.00001 | | (Aperture |
| | | | | Stop S) |
| 7* | 7.88532 | 3.27835 | 1.497103 | 81.56 |
| 8* | −34.39026 | 0.23036 | | |
| 9 | 11.14049 | 0.80000 | 1.902000 | 25.26 |
| 10 | 7.58072 | 1.30775 | | |
| 11* | 28.25287 | 1.21737 | 1.592014 | 67.02 |
| 12* | 78.20653 | (D12) | | |
| 13 | 454.51671 | 1.22144 | 1.497103 | 81.56 |
| 14* | −170.72900 | 6.54398 | | |
| 15* | −7.99852 | 0.99989 | 1.693500 | 53.20 |
| 16* | −18.66958 | (D16) | | |
| 17 | −21.11056 | 2.02301 | 1.592014 | 67.02 |
| 18* | −19.25768 | (D18) | | |
| 19 | −27.35915 | 3.73536 | 1.922859 | 20.88 |
| 20 | −20.67766 | 8.25000 | | |
| 21 | ∞ | 1.60000 | 1.516800 | 63.88 |
| 22 | ∞ | 1.00000 | | |

[Aspherical Surface Data]

7th Surface
κ = 1.0000, A4 = −6.17249E−05, A6 = 3.64790E−06,
A8 = −9.46230E−08, A10 = 0.00000E+00
8th Surface
κ = 1.0000, A4 = 9.09449E−04, A6 = −1.31033E−05,
A8 = −3.57776E−08, A10 = 0.00000E+00
11th Surface
κ = 1.0000, A4 = 2.30528E−03, A6 = −1.53067E−05,
A8 = 0.00000E+00, A10 = 0.00000E+00
12th Surface
κ = 1.0000, A4 = 1.76391E−03, A6 = 1.29596E−05,
A8 = 0.00000E+00, A10 = 0.00000E+00
14th Surface
κ = 1.0000, A4 = −1.34128E−04, A6 = −2.58817E−06,
A8 = 0.00000E+00, A10 = 0.00000E+00
15th Surface
κ = 1.0000, A4 = 5.19818E−05, A6 = −2.82181E−06,
A8 = −3.64480E−08, A10 = 0.00000E+00
16th Surface
κ = 1.0000, A4 = 4.75476E−05, A6 = −2.23750E−06,
A8 = 1.49381E−08, A10 = 0.00000E+00
18th Surface
κ = 1.0000, A4 = 4.49129E−05, A6 = −1.00014E−08,
A8 = 1.38726E−10, A10 = 0.00000E+00

[Variable Distance Data]

| | | |
|---|---|---|
| W | M | T |

Upon focusing on infinity

| | | | |
|---|---|---|---|
| Focal length | 28.736 | 39.996 | 48.484 |
| Distance | ∞ | ∞ | ∞ |
| D5 | 11.148 | 4.372 | 1.500 |
| D12 | 0.803 | 0.799 | 0.799 |
| D16 | 3.074 | 7.916 | 13.015 |
| D18 | 0.500 | 1.205 | 0.500 |

Upon focusing on a very short distance object

| | | | |
|---|---|---|---|
| Magnification | −0.112 | −0.160 | −0.198 |
| Distance | 246.297 | 247.338 | 246.009 |
| D5 | 11.148 | 4.372 | 1.500 |
| D12 | 2.887 | 3.704 | 4.271 |
| D16 | 0.990 | 5.010 | 9.543 |
| D18 | 0.500 | 1.205 | 0.500 |

[Lens Group Data]

| | First | Focal |
|---|---|---|
| Group | surface | length |
| G1 | 1 | −40.394 |
| G2 | 7 | 16.507 |
| G3 | 13 | −23.557 |
| G4 | 17 | 263.594 |
| G5 | 19 | 72.338 |

FIG. 10A is a variety of aberration diagrams of the zoom optical system according to the fifth example upon focusing on infinity in the wide-angle end state. FIG. 10B is a variety of aberration diagrams of the zoom optical system according to the fifth example upon focusing on infinity in the telephoto end state. From the variety of aberration diagrams, it can be understood that the zoom optical system according to the fifth example has a variety of aberrations excellently corrected in both the wide-angle end state and the telephoto end state and has excellent imaging performance.

### Sixth Example

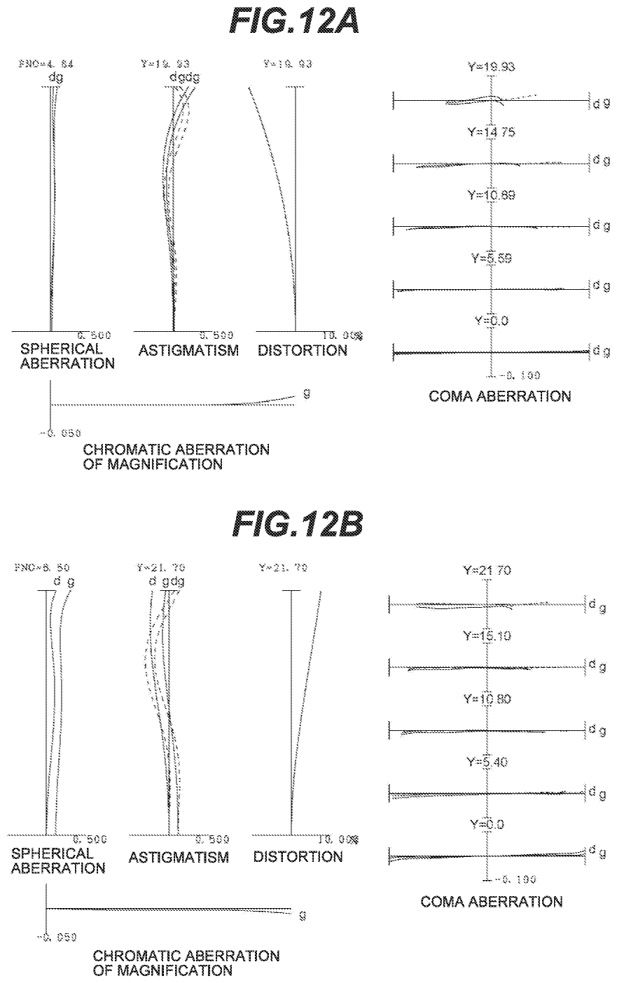

The sixth example will be described below with reference to FIGS. 11, 12A, 12B and Table 6. FIG. 11 is a diagram showing a lens configuration of the zoom optical system according to the sixth example. The zoom optical system according to the sixth example ZL(6) comprises a first lens group G1 having negative refractive power, an aperture stop S, a second lens group G2 having positive refractive power, a third lens group G3 having negative refractive power, a fourth lens group G4 having positive refractive power, and a fifth lens group G5 having positive refractive power, the lens groups being arranged in order from an object side along an optical axis. Upon zooming from the wide-angle end state (W) to the telephoto end state (T), the first lens group G1 temporarily moves to the image side along the optical axis and then moves to the object side, the second lens group G2, the third lens group G3, and the fourth lens group G4 move to the object side along the optical axis, and the space between the lens groups adjacent to each other changes. Upon zooming, the aperture stop S moves along the optical axis together with the second lens group G2 and the position of the fifth lens group G5 is fixed relative to the image surface I.

The first lens group G1 includes a cemented lens constituted by a plano-convex positive lens L11 having a flat surface toward the object side and a biconcave negative lens L12, and a biconcave negative lens L13, the lenses being arranged in order from an object side along an optical axis.

The second lens group G2 includes a biconvex positive lens L21, a biconcave negative lens L22, a positive meniscus lens L23 having a concave surface toward the object side, and a negative meniscus lens L24 having a concave surface toward the object side, the lenses being arranged in order from an object side along an optical axis. The positive lens L21 has aspherical lens surfaces on both sides. The negative lens L22 has aspherical lens surfaces on both sides. The negative meniscus lens L24 has aspherical lens surfaces on both sides.

The third lens group G3 includes a negative meniscus lens L31 having a concave surface toward the object side. The negative meniscus lens L31 has aspherical lens surfaces on both sides.

The fourth lens group G4 includes a positive meniscus lens L41 having a concave surface toward the object side. The fifth lens group G5 includes a positive meniscus lens L51 having a concave surface toward the object side. The positive meniscus lens L51 has an aspherical lens surface on the image side. The image surface I is disposed on the image side of the fifth lens group G5. In addition, a parallel flat plate PP is disposed between the fifth lens group G5 and the image surface I.

In the present example, the second lens group G2, the third lens group G3, the fourth lens group G4, and the fifth lens group G5 serve as the rear group GR having positive refractive power as a whole. The fifth lens group G5 corresponds to the final lens group GE disposed closest to the image side in the rear group GR. The entire third lens group G3 serves as the focusing group GF that moves along the optical axis upon focusing. Upon focusing on from an infinite distance object to a close distance object, the focusing group GF (entire third lens group G3) moves to the image side along the optical axis. The fourth lens group G4 (positive meniscus lens L41) and the fifth lens group G5 (positive meniscus lens L51) serve as the image-side lens group GFR of lenses disposed closer to the image side than the focusing group GF.

Table 6 below shows data values of the zoom optical system according to the sixth example.

TABLE 6
[General Data]

| | |
|---|---|
| Zooming ratio = 1.688 | |
| fF = −17.191 | |
| fRw = 22.576 | fRt = 28.450 |
| fFRw = 31.580 | fFRt = 34.233 |
| fRPF = 17.401 | fRPR = 62.135 |
| βRw = −0.663 | βRt = −1.119 |

| | W | M | T |
|---|---|---|---|
| f | 28.734 | 40.000 | 48.492 |
| FNO | 4.635 | 5.755 | 6.489 |
| ω | 38.247 | 27.621 | 22.588 |
| Y | 19.934 | 21.700 | 21.700 |
| TL | 55.196 | 53.860 | 55.196 |
| Bf | 10.305 | 10.330 | 10.305 |

[Lens Data]

| Surface | | | | |
|---|---|---|---|---|
| Number | R | D | nd | νd |
| 1 | ∞ | 1.62184 | 1.922859 | 20.88 |
| 2 | −98.98277 | 0.89162 | 1.593190 | 67.90 |
| 3 | 77.82625 | 1.79570 | | |
| 4 | −33.56157 | 0.89112 | 1.593190 | 67.90 |
| 5 | 589.10769 | (D5) | | |
| 6 | ∞ | 1.00000 | | (Aperture |
| | | | | Stop S) |
| 7* | 6.70273 | 3.12536 | 1.497103 | 81.56 |
| 8* | −30.15078 | 0.57764 | | |
| 9* | −55.84253 | 0.80000 | 1.635500 | 23.89 |
| 10* | 44.80145 | 2.17402 | | |
| 11 | −8.34724 | 1.43673 | 1.496997 | 81.61 |
| 12 | −6.40691 | 0.22961 | | |
| 13* | −4.92101 | 0.82001 | 1.497103 | 81.56 |
| 14* | −7.35389 | (D14) | | |
| 15* | −10.06431 | 1.00010 | 1.851348 | 40.10 |
| 16* | −33.69524 | (D16) | | |
| 17 | −2610.17570 | 2.58513 | 1.922859 | 20.88 |
| 18 | −54.86830 | (D18) | | |
| 19 | −71.71870 | 2.86404 | 1.768015 | 49.24 |
| 20* | −29.15141 | 8.25000 | | |
| 21 | ∞ | 1.60000 | 1.516800 | 63.88 |
| 22 | ∞ | 1.00000 | | |

[Aspherical Surface Data]

7th Surface
κ = 1.0000, A4 = 6.34976E−06, A6 = 1.73361E−06,
A8 = 0.00000E+00, A10 = 0.00000E+00
8th Surface
κ = 1.0000, A4 = 4.68148E−04, A6 = −8.06904E−06,
A8 = 0.00000E+00, A10 = 0.00000E+00
9th Surface
κ = 1.0000, A4 = 1.27100E−03, A6 = −2.18846E−05,
A8 = 0.00000E+00, A10 = 0.00000E+00
10th Surface
κ = 1.0000, A4 = 1.33096E−03, A6 = −1.45423E−06,
A8 = 0.00000E+00, A10 = 0.00000E+00
13th Surface
κ = 1.0000, A4 = 2.30483E−03, A6 = −1.88231E−05,
A8 = 0.00000E+00, A10−0.00000E+00
14th Surface
κ = 1.0000, A4 = 2.04780E−03, A6 = −2.37072E−05,
A8 = 0.00000E+00, A10 = 0.00000E+00
15th Surface
κ = 1.0000, A4 = 1.26184E−04, A6 = 1.03823E−06,
A8 = 1.21180E−08, A10 = 0.00000E+00
16th Surface
κ = 1.0000, A4 = 2.47523E−05, A6 = 2.27287E−07,
A8 = −9.41887E−10, A10 = 0.00000E+00
20th Surface
κ = 1.0000, A4−2.56873E−05, A6 = −1.19279E−08,
A8 = 0.00000E+00, A10 = 0.00000E+00

[Variable Distance Data]

| | | |
|---|---|---|
| W | M | T |

Upon focusing on infinity

| | | | |
|---|---|---|---|
| Focal length | 28.734 | 40.000 | 48.492 |
| Distance | ∞ | ∞ | ∞ |
| D5 | 12.551 | 4.940 | 1.517 |
| D14 | 7.484 | 7.721 | 7.834 |
| D16 | 2.261 | 3.253 | 3.690 |
| D18 | 0.781 | 5.803 | 10.038 |

Upon focusing on a very short distance object

| | | | |
|---|---|---|---|
| Magnification | −0.113 | −0.162 | −0.203 |
| Distance | 244.259 | 245.595 | 244.259 |
| D5 | 12.551 | 4.940 | 1.517 |
| D14 | 9.287 | 10.353 | 11.105 |
| D16 | 0.458 | 0.621 | 0.419 |
| D18 | 0.781 | 5.803 | 10.038 |

[Lens Group Data]

| | First | Focal |
|---|---|---|
| Group | surface | length |
| G1 | 1 | −43.328 |
| G2 | 7 | 17.401 |
| G3 | 15 | −17.191 |
| G4 | 17 | 60.702 |
| G5 | 19 | 62.135 |

FIG. 12A is a variety of aberration diagrams of the zoom optical system according to the sixth example upon focusing on infinity in the wide-angle end state. FIG. 12B is a variety of aberration diagrams of the zoom optical system according to the sixth example upon focusing on infinity in the telephoto end state. From the variety of aberration diagrams, it can be understood that the zoom optical system according to the sixth example has a variety of aberrations excellently corrected in both the wide-angle end state and the telephoto end state and has excellent imaging performance.

### Seventh Example

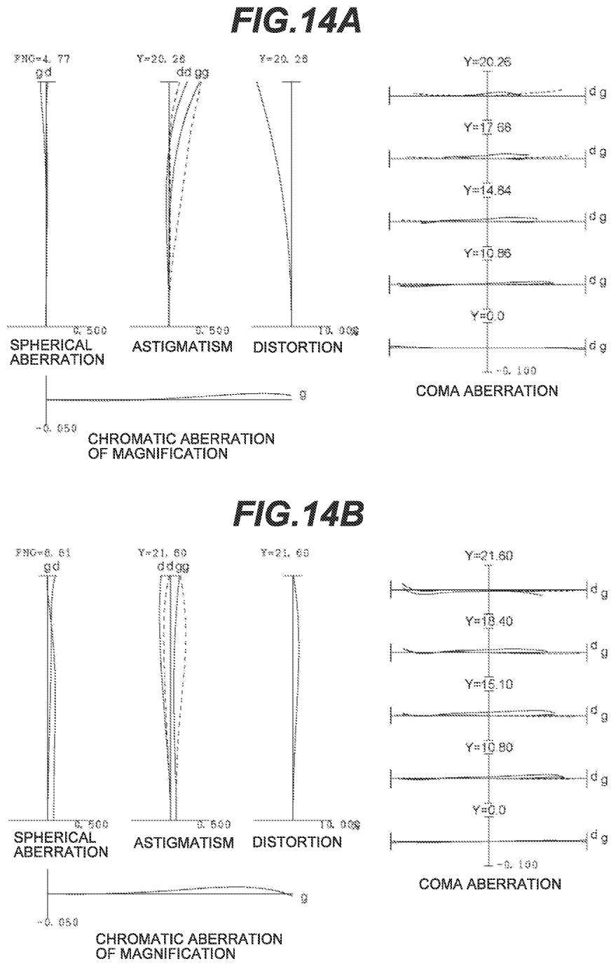

The seventh example will be described below with reference to FIGS. 13, 14A, 14B and Table 7. FIG. 13 is a diagram showing a lens configuration of the zoom optical system according to the seventh example. The zoom optical system according to the seventh example ZL(7) comprises a first lens group G1 having negative refractive power, an aperture stop S, a second lens group G2 having positive refractive power, a third lens group G3 having positive refractive power, a fourth lens group G4 having negative refractive power, and a fifth lens group G5 having positive refractive power, the lens groups being arranged in order from an object side along an optical axis. Upon zooming from the wide-angle end state (W) to the telephoto end state (T), the first lens group G1, the second lens group G2, the third lens group G3, and the fourth lens group G4 move to the object side along the optical axis, and the space between the lens groups adjacent to each other changes. Upon zooming, the aperture stop S moves along the optical axis together with the second lens group G2 and the position of the fifth lens group G5 is fixed relative to the image surface I.

The first lens group G1 includes a biconcave negative lens L11, and a positive meniscus lens L12 having a convex surface toward the object side, the lenses being arranged in order from an object side along an optical axis. The negative lens L11 has aspherical lens surfaces on both sides.

The second lens group G2 includes a positive meniscus lens L21 having a convex surface toward the object side, a biconvex positive lens L22, and a negative meniscus lens L23 having a convex surface toward the object side, the lenses being arranged in order from an object side along an optical axis. The positive meniscus lens L21 has aspherical lens surfaces on both sides.

The third lens group G3 includes a negative meniscus lens L31 having a concave surface toward the object side, and a biconvex positive lens L32, the lenses being arranged in order from an object side along an optical axis. The positive lens L32 has an aspherical lens surface on the image side.

The fourth lens group G4 includes a negative meniscus lens L41 having a concave surface toward the object side. The negative meniscus lens L41 has an aspherical lens surface on the object side.

The fifth lens group G5 includes a positive meniscus lens L51 having a concave surface toward the object side. The positive meniscus lens L51 has an aspherical lens surface on the image side. The image surface I is disposed on the image side of the fifth lens group G5.

In the present example, the second lens group G2, the third lens group G3, the fourth lens group G4, and the fifth lens group G5 serve as the rear group GR having positive refractive power as a whole. The fifth lens group G5 corresponds to the final lens group GE disposed closest to the image side in the rear group GR. The entire third lens group G3 serves as the focusing group GF that moves along the optical axis upon focusing. Upon focusing on from an infinite distance object to a close distance object, the focusing group GF (entire third lens group G3) moves to the object side along the optical axis. The fourth lens group G4 (negative meniscus lens L41) and the fifth lens group G5 (positive meniscus lens L51) serve as the image-side lens group GFR of lenses disposed closer to the image side than the focusing group GF.

Table 7 below shows data values of the zoom optical system according to the seventh example.

TABLE 7
[General Data]

| | |
|---|---|
| Zooming ratio = 1.636 | |
| fF = 39.167 | |
| fRw = 22.595 | fRt = 29.061 |
| fFRw = −41.499 | fFRt = −59.874 |
| fRPF = 20.954 | fRPR = 70.338 |
| βRw = −0.617 | βRt = −1.010 |

| | W | M | T |
|---|---|---|---|
| f | 29.700 | 38.460 | 48.600 |
| FNO | 4.760 | 5.730 | 6.600 |
| ω | 36.800 | 30.000 | 23.900 |
| Y | 20.260 | 21.600 | 21.600 |
| TL | 53.000 | 54.360 | 55.000 |
| Bf | 9.350 | 9.350 | 9.350 |

[Lens Data]

| Surface | | | | |
|---|---|---|---|---|
| Number | R | D | nd | νd |
| 1* | −46.45344 | 0.70000 | 1.592450 | 66.92 |
| 2* | 32.53983 | 0.27192 | | |
| 3 | 31.89076 | 1.16857 | 1.922860 | 20.88 |
| 4 | 49.15523 | (D4) | | |
| 5 | ∞ | 0.75000 | | (Aperture |
| | | | | Stop S) |
| 6* | 9.25078 | 1.69319 | 1.592550 | 67.86 |
| 7* | 22.86502 | 0.52358 | | |
| 8* | 21.08977 | 2.02472 | 1.497103 | 81.56 |
| 9 | −33.77515 | 0.10000 | | |
| 10 | 14.66767 | 0.60000 | 1.805180 | 25.45 |
| 11 | 8.87343 | (D11) | | |
| 12 | −10.72084 | 0.60000 | 1.647690 | 33.72 |
| 13 | −88.96305 | 0.10000 | | |
| 14 | 153.50950 | 4.46285 | 1.806040 | 40.74 |
| 15* | −12.62204 | (D15) | | |
| 16* | −12.55590 | 1.10000 | 1.592550 | 67.86 |
| 17 | −124.66776 | (D17) | | |
| 18 | −76.00140 | 4.00911 | 1.806040 | 40.74 |
| 19* | −33.23634 | Bf | | |

[Aspherical Surface Data]

1st Surface
κ = 1.0000, A4 = −2.87832E−05, A6 = 5.37667E−07,
A8 = −1.89799E−09, A10 = 0.00000E+00
2nd Surface
κ = 1.0000, A4 = −3.52496E−05, A6 = 4.89315E−07,
A8 = 0.00000E+00, A10 = 0.00000E+00
6th Surface
κ = 1.0000, A4 = 4.25254E−04, A6 = 6.57900E−06,
A8 = 0.00000E+00, A10 = 0.00000E+00
7th Surface
κ = 1.0000, A4 = 1.56672E−03, A6 = −2.37553E−06,
A8 = 0.00000E+00, A10−0.00000E+00
8th Surface
κ = 1.0000, A4 = 1.07233E−03, A6 = −1.74719E−05,
A8 = 0.00000E+00, A10 = 0.00000E+00
15th Surface
κ = 1.0000, A4 = 5.95097E−05, A6 = 2.02778E−07,
A8 = 0.00000E+00, A10 = 0.00000E+00
16th Surface
κ = 1.0000, A4 = 6.61988E−05, A6 = 3.19123E−08,
A8 = 0.00000E+00, A10 = 0.00000E+00
19th Surface
κ = 1.0000, A4 = 1.04032E−05, A6 = −1.75552E−08,
A8 = 0.00000E+00, A10 = 0.00000E+00

[Variable Distance Data]

| | | |
|---|---|---|
| W | M | T |

Upon focusing on infinity

| | | | |
|---|---|---|---|
| Focal length | 29.700 | 38.460 | 48.600 |
| Distance | ∞ | ∞ | ∞ |
| D4 | 9.80415 | 5.69022 | 0.77539 |
| D11 | 7.02876 | 8.50376 | 7.42174 |
| D15 | 6.66505 | 4.79534 | 5.00000 |
| D17 | 2.04808 | 7.91189 | 14.34901 |

Upon focusing on a very short distance object

| | | | |
|---|---|---|---|
| Magnification | −0.09457 | −0.12295 | −0.15908 |
| Distance | 300.0000 | 300.0000 | 300.0000 |
| D4 | 9.80415 | 5.69022 | 0.77539 |
| D11 | 4.41909 | 5.26604 | 3.84392 |
| D15 | 9.27473 | 8.03306 | 8.57782 |
| D17 | 2.04808 | 7.91189 | 14.34901 |

[Lens Group Data]

| | First | Focal |
|---|---|---|
| Group | surface | length |
| G1 | 1 | −48.133 |
| G2 | 6 | 20.954 |
| G3 | 12 | 39.167 |
| G4 | 16 | −23.649 |
| G5 | 18 | 70.338 |

FIG. 14A is a variety of aberration diagrams of the zoom optical system according to the seventh example upon focusing on infinity in the wide-angle end state. FIG. 14B is a variety of aberration diagrams of the zoom optical system according to the seventh example upon focusing on infinity in the telephoto end state. From the variety of aberration diagrams, it can be understood that the zoom optical system according to the seventh example has a variety of aberrations excellently corrected in both the wide-angle end state and the telephoto end state and has excellent imaging performance.

### Eighth Example

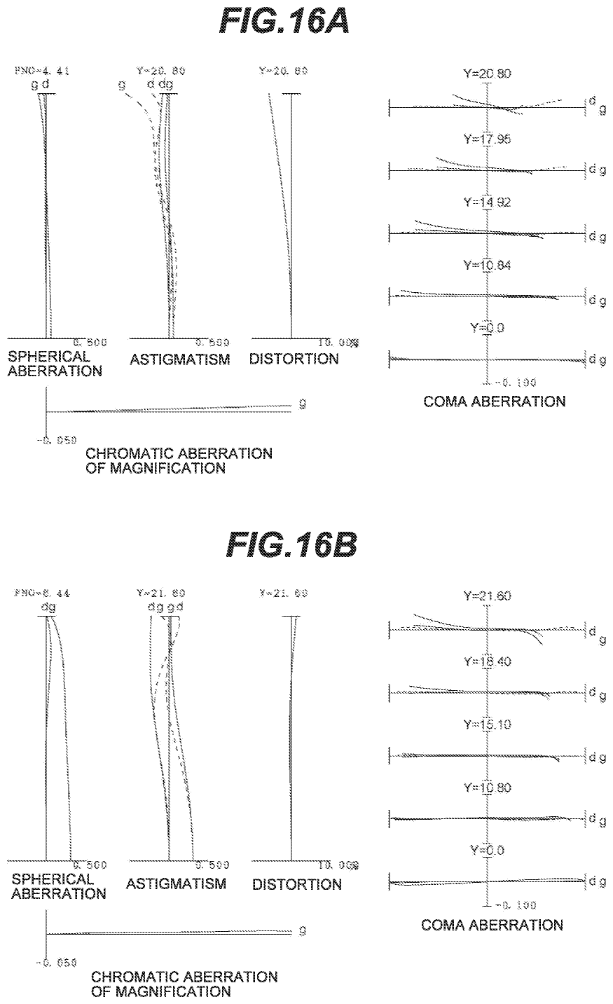

The eighth example will be described below with reference to FIGS. 15, 16A, 16B and Table 8. FIG. 15 is a diagram showing a lens configuration of the zoom optical system according to the eighth example. The zoom optical system according to the eighth example ZL(8) comprises a first lens group G1 having negative refractive power, an aperture stop S, a second lens group G2 having positive refractive power, a third lens group G3 having positive refractive power, a fourth lens group G4 having negative refractive power, and a fifth lens group G5 having positive refractive power, the lens groups being arranged in order from an object side along an optical axis. Upon zooming from the wide-angle end state (W) to the telephoto end state (T), the first lens group G1, the second lens group G2, the third lens group G3, and the fourth lens group G4 move to the object side along the optical axis, and the space between the lens groups adjacent to each other changes. Upon zooming, the aperture stop S moves along the optical axis together with the second lens group G2 and the position of the fifth lens group G5 is fixed relative to the image surface I.

The first lens group G1 includes a biconcave negative lens L11 and a biconvex positive lens L12, the lenses being arranged in order from an object side along an optical axis. The negative lens L11 has aspherical lens surfaces on both sides.

The second lens group G2 includes a biconvex positive lens L21, and a negative meniscus lens L22 having a convex surface toward the object side, the lenses being arranged in order from an object side along an optical axis. The positive lens L21 has aspherical lens surfaces on both sides.

The third lens group G3 includes a negative meniscus lens L31 having a concave surface toward the object side, and a biconvex positive lens L32, the lenses being arranged in order from an object side along an optical axis. The positive lens L32 has an aspherical lens surface on the image side.

The fourth lens group G4 includes a negative meniscus lens L41 having a convex surface toward the object side, and a negative meniscus lens L42 having a concave surface toward the object side, the lenses being arranged in order from an object side along an optical axis. The negative meniscus lens L42 has an aspherical lens surface on the image side.

The fifth lens group G5 includes a positive meniscus lens L51 having a concave surface toward the object side. The positive meniscus lens L51 has an aspherical lens surface on the image side. The image surface I is disposed on the image side of the fifth lens group G5.

In the present example, the second lens group G2, the third lens group G3, the fourth lens group G4, and the fifth lens group G5 serve as the rear group GR having positive refractive power as a whole. The fifth lens group G5 corresponds to the final lens group GE disposed closest to the image side in the rear group GR. The entire third lens group G3 serves as the focusing group GF that moves along the optical axis upon focusing. Upon focusing on from an infinite distance object to a close distance object, the focusing group GF (entire third lens group G3) moves to the object side along the optical axis. The fourth lens group G4 (negative meniscus lens L41 and negative meniscus lens L42) and the fifth lens group G5 (positive meniscus lens L51) serve as the image-side lens group GFR of lenses disposed closer to the image side than the focusing group GF.

Table 8 below shows data values of the zoom optical system according to the eighth example.

TABLE 8
[General Data]

| | |
|---|---|
| Zooming ratio = 1.636 | |
| fF = 26.338 | |
| fRw = 26.032 | fRt = 58.204 |
| fFRw = −29.697 | fFRt = −53.723 |
| fRPF = 21.696 | fRPR = 55.306 |
| βRw = −0.449 | βRt = −0.601 |

| | W | M | T |
|---|---|---|---|
| f | 29.700 | 38.000 | 48.600 |
| FNO | 4.760 | 5.730 | 6.600 |
| ω | 36.600 | 29.600 | 23.700 |
| Y | 20.800 | 21.600 | 21.600 |
| TL | 49.450 | 41.640 | 54.950 |
| Bf | 9.400 | 9.410 | 9.400 |

[Lens Data]

| Surface | | | | |
|---|---|---|---|---|
| Number | R | D | nd | νd |
| 1* | −30.00033 | 0.70000 | 1.677980 | 54.89 |
| 2* | 27.02686 | 0.30000 | | |
| 3 | 44.93551 | 1.30000 | 2.001000 | 29.12 |
| 4 | −169.34876 | (D4) | | |
| 5 | ∞ | 0.75000 | | (Aperture |
| | | | | Stop S) |
| 6* | 8.93744 | 2.40000 | 1.497103 | 81.56 |
| 7* | −41.28092 | 0.10000 | | |
| 8 | 9.85432 | 0.85000 | 1.846660 | 23.80 |
| 9 | 7.22445 | (D9) | | |
| 10 | −9.42267 | 0.60000 | 1.592700 | 35.27 |
| 11 | −36.11138 | 0.53556 | | |
| 12 | 44.47304 | 3.77778 | 1.658440 | 50.83 |
| 13* | −10.73978 | (D13) | | |
| 14 | 83.46657 | 0.60000 | 1.677980 | 54.89 |
| 15 | 19.47713 | 7.71820 | | |
| 16 | −9.23773 | 1.10000 | 1.592550 | 67.86 |
| 17* | −18.61767 | (D17) | | |
| 18 | −48.35114 | 4.85915 | 1.820980 | 42.50 |
| 19* | −24.47680 | Bf | | |

[Aspherical Surface Data]

1st Surface
κ = 1.0000, A4 = 7.08353E−07, A6 = −7.32782E−08,
A8 = 1.68078E−10, A10 = 0.00000E+00
2nd Surface
κ = 1.0000, A4 = −2.56974E−05, A6 = −1.03240E−07,
A8 = 0.00000E+00, A10 = 0.00000E+00
6th Surface
κ = 1.0000, A4 = −1.17527E−04, A6 = −1.07846E−06,
A8 = 0.00000E+00, A10 = 0.00000E+00
7th Surface
κ = 1.0000, A4 = 4.05573E−05, A6 = −1.34572E−08,
A8 = 0.00000E+00, A10 = 0.00000E+00
13th Surface
κ = 1.0000, A4 = 1.20435E−04, A6 = 5.06907E−07,
A8 = 0.00000E+00, A10 = 0.00000E+00
17th Surface
κ = 1.0000, A4 = −4.34454E−05, A6 = −1.59225E−07,
A8 = 0.00000E+00, A10 = 0.00000E+00
19th Surface
κ = 1.0000, A4 = 3.48547E−06, A6 = 1.98136E−08,
A8 = 0.00000E+00, A10 = 0.00000E+00

[Variable Distance Data]

| | | |
|---|---|---|
| W | M | T |

Upon focusing on infinity

| | | | |
|---|---|---|---|
| Focal length | 29.700 | 38.000 | 48.600 |
| Distance | ∞ | ∞ | ∞ |
| D4 | 7.79982 | 3.90180 | 0.75000 |
| D9 | 3.42610 | 3.93525 | 4.42251 |
| D13 | 2.53363 | 1.66766 | 0.90000 |
| D17 | 0.70000 | 6.54202 | 13.88678 |

Upon focusing on a very short distance object

| | | | |
|---|---|---|---|
| Magnification | −0.09863 | −0.12512 | −0.16148 |
| Distance | 300.0000 | 300.0000 | 300.0000 |
| D4 | 7.79982 | 3.90180 | 0.75000 |
| D9 | 2.26584 | 2.56819 | 2.84604 |
| D13 | 3.69388 | 3.03472 | 2.47647 |
| D17 | 0.70000 | 6.54202 | 13.88678 |

[Lens Group Data]

| | First | Focal |
|---|---|---|
| Group | surface | length |
| G1 | 1 | −52.725 |
| G2 | 6 | 21.696 |
| G3 | 10 | 26.338 |
| G4 | 14 | −15.833 |
| G5 | 18 | 55.306 |

FIG. 16A is a variety of aberration diagrams of the zoom optical system according to the eighth example upon focusing on infinity in the wide-angle end state. FIG. 16B is a variety of aberration diagrams of the zoom optical system according to the eighth example upon focusing on infinity in the telephoto end state. From the variety of aberration diagrams, it can be understood that the zoom optical system according to the eighth example has a variety of aberrations excellently corrected in both the wide-angle end state and the telephoto end state and has excellent imaging performance.

### Ninth Example

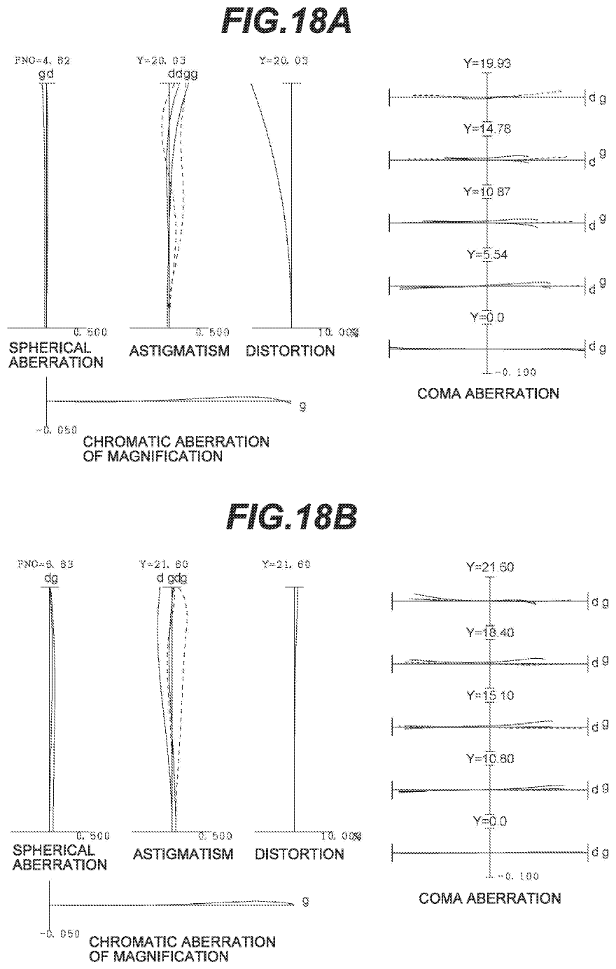

The ninth example will be described below with reference to FIGS. 17, 18A, 18B and Table 9. FIG. 17 is a diagram showing a lens configuration of the zoom optical system according to the ninth example. The zoom optical system according to the ninth example ZL(9) comprises a first lens group G1 having negative refractive power, an aperture stop S, a second lens group G2 having positive refractive power, a third lens group G3 having positive refractive power, a fourth lens group G4 having negative refractive power, and a fifth lens group G5 having positive refractive power, the lens groups being arranged in order from an object side along an optical axis. Upon zooming from the wide-angle end state (W) to the telephoto end state (T), the first lens group G1, the second lens group G2, the third lens group G3, and the fourth lens group G4 move to the object side along the optical axis, and the space between the lens groups adjacent to each other changes. Upon zooming, the aperture stop S moves along the optical axis together with the second lens group G2 and the position of the fifth lens group G5 is fixed relative to the image surface I.

The first lens group G1 includes a biconcave negative lens L11, and a positive meniscus lens L12 having a convex surface toward the object side, the lenses being arranged in order from an object side along an optical axis. The negative lens L11 has aspherical lens surfaces on both sides.

The second lens group G2 includes a positive meniscus lens L21 having a convex surface toward the object side, a positive meniscus lens L22 having a convex surface toward the object side, and a negative meniscus lens L23 having a convex surface toward the object side, the lenses being arranged in order from an object side along an optical axis. The positive meniscus lens L21 has aspherical lens surfaces on both sides.

The third lens group G3 includes a negative meniscus lens L31 having a concave surface toward the object side, and a biconvex positive lens L32, the lenses being arranged in order from an object side along an optical axis. The positive lens L32 has an aspherical lens surface on the image side.

The fourth lens group G4 includes a negative meniscus lens L41 having a concave surface toward the object side. The negative meniscus lens L41 has an aspherical lens surface on the image side.

The fifth lens group G5 includes a positive meniscus lens L51 having a concave surface toward the object side. The positive meniscus lens L51 has an aspherical lens surface on the image side. The image surface I is disposed on the image side of the fifth lens group G5.

In the present example, the second lens group G2, the third lens group G3, the fourth lens group G4, and the fifth lens group G5 serve as the rear group GR having positive refractive power as a whole. The fifth lens group G5 corresponds to the final lens group GE disposed closest to the image side in the rear group GR. The entire third lens group G3 serves as the focusing group GF that moves along the optical axis upon focusing. Upon focusing on from an infinite distance object to a close distance object, the focusing group GF (entire third lens group G3) moves to the object side along the optical axis. The fourth lens group G4 (negative meniscus lens L41) and the fifth lens group G5 (positive meniscus lens L51) serve as the image-side lens group GFR of lenses disposed closer to the image side than the focusing group GF.

Table 9 below shows data values of the zoom optical system according to the ninth example.

TABLE 9
[General Data]

| | |
|---|---|
| Zooming ratio = 1.636 | |
| fF = 42.997 | |
| fRw = 28.117 | fRt = 47.910 |
| fFRw = −53.580 | fFRt = −76.170 |
| fRPF = 23.675 | fRPR = 80.136 |
| βRw = −0.471 | βRt = −0.612 |

| | W | M | T |
|---|---|---|---|
| f | 29.700 | 38.000 | 48.600 |
| FNO | 4.620 | 5.500 | 6.630 |
| ω | 36.950 | 30.400 | 23.770 |
| Y | 20.030 | 21.600 | 21.600 |
| TL | 53.000 | 53.500 | 56.560 |
| Bf | 9.350 | 9.350 | 9.350 |

[Lens Data]

| Surface | | | | |
|---|---|---|---|---|
| Number | R | D | nd | νd |
| 1* | −31.73727 | 0.70000 | 1.497103 | 81.56 |
| 2* | 29.09010 | 0.44719 | | |
| 3 | 43.66364 | 1.20961 | 2.000690 | 25.46 |
| 4 | 122.92529 | (D4) | | |
| 5 | ∞ | 0.75000 | | (Aperture |
| | | | | Stop S) |
| 6* | 12.35536 | 1.63881 | 1.497103 | 81.56 |
| 7* | 57.04352 | 0.10000 | | |
| 8 | 12.73259 | 1.70614 | 1.496997 | 81.61 |
| 9 | 197.72930 | 0.10000 | | |
| 10 | 13.90270 | 0.60000 | 1.784720 | 25.64 |
| 11 | 8.83064 | (D11) | | |
| 12 | −12.80974 | 0.55000 | 1.749500 | 35.25 |
| 13 | −617.21941 | 0.10000 | | |
| 14 | 71.30483 | 5.01710 | 1.820980 | 42.50 |
| 15* | −13.72803 | (D15) | | |
| 16 | −13.40787 | 1.10000 | 1.563840 | 60.71 |
| 17* | −68.71419 | (D17) | | |
| 18 | −45.00000 | 3.23796 | 1.902650 | 35.77 |
| 19* | −28.68872 | Bf | | |

[Aspherical Surface Data]

1st Surface
κ = 1.0000, A4 = 6.95146E−06, A6 = 7.90721E−08,
A8 = −4.86954E−10, A10 = 0.00000E+00
2nd Surface
κ = 1.0000, A4 = −1.21033E−05, A6 = 4.19563E−08,
A8 = 0.00000E+00, A10 = 0.00000E+00
6th Surface
κ = 1.0000, A4 = −3.26113E−05, A6 = 5.99810E−07,
A8 = 0.00000E+00, A10 = 0.00000E+00
7th Surface
κ = 1.0000, A4 = 4.51406E−05, A6 = 7.80522E−07,
A8 = 0.00000E+00, A10 = 0.00000E+00
15th Surface
κ = 1.0000, A4 = 5.20915E−05, A6 = 1.39991E−07,
A8 = 0.00000E+00, A10 = 0.00000E+00
17th Surface
κ = 1.0000, A4 = −3.68987E−05, A6 = 7.05431E−08,
A8 = 0.00000E+00, A10 = 0.00000E+00
19th Surface
κ = 1.0000, A4 = 2.55064E−06, A6 = 1.13229E−08,
A8 = 0.00000E+00, A10 = 0.00000E+00

[Variable Distance Data]

| | | |
|---|---|---|
| W | M | T |

Upon focusing on infinity

| | | | |
|---|---|---|---|
| Focal length | 29.700 | 38.000 | 48.600 |
| Distance | ∞ | ∞ | ∞ |
| D4 | 8.70643 | 4.12083 | 0.50000 |
| D11 | 6.88074 | 8.48181 | 10.47382 |
| D15 | 10.10609 | 7.59408 | 5.07986 |
| D17 | 0.70000 | 6.69783 | 13.89998 |

Upon focusing on a very short distance object

| | | | |
|---|---|---|---|
| Magnification | −0.09550 | −0.12308 | −0.15793 |
| Distance | 300.0000 | 300.0000 | 300.0000 |
| D4 | 8.70643 | 4.12083 | 0.50000 |
| D11 | 3.91794 | 4.80666 | 5.95890 |
| D15 | 13.06889 | 11.26923 | 9.59478 |
| D17 | 0.70000 | 6.69783 | 13.89998 |

[Lens Group Data]

| | First | Focal |
|---|---|---|
| Group | surface | length |
| G1 | 1 | −56.116 |
| G2 | 6 | 23.675 |
| G3 | 12 | 42.997 |
| G4 | 16 | −29.758 |
| G5 | 18 | 80.136 |

FIG. 18A is a variety of aberration diagrams of the zoom optical system according to the ninth example upon focusing on infinity in the wide-angle end state. FIG. 18B is a variety of aberration diagrams of the zoom optical system according to the ninth example upon focusing on infinity in the telephoto end state. From the variety of aberration diagrams, it can be understood that the zoom optical system according to the ninth example has a variety of aberrations excellently corrected in both the wide-angle end state and the telephoto end state and has excellent imaging performance.

### Tenth Example

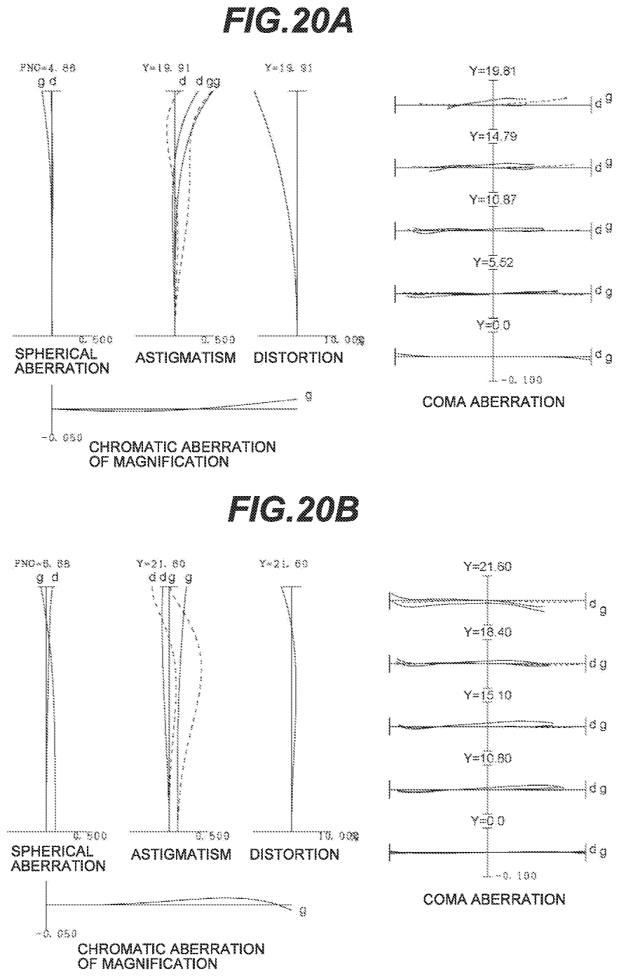

The tenth example will be described below with reference to FIGS. 19, 20A, 20B and Table 10. FIG. 19 is a diagram showing a lens configuration of the zoom optical system according to the tenth example. The zoom optical system according to the tenth example ZL(10) comprises a first lens group G1 having negative refractive power, an aperture stop S, a second lens group G2 having positive refractive power, a third lens group G3 having positive refractive power, a fourth lens group G4 having negative refractive power, and a fifth lens group G5 having positive refractive power, the lens groups being arranged in order from an object side along an optical axis. Upon zooming from the wide-angle end state (W) to the telephoto end state (T), the first lens group G1, the second lens group G2, the third lens group G3, and the fourth lens group G4 move to the object side along the optical axis, and the space between the lens groups adjacent to each other changes. Upon zooming, the aperture stop S moves along the optical axis together with the second lens group G2 and the position of the fifth lens group G5 is fixed relative to the image surface I.

The first lens group G1 includes a biconcave negative lens L11, and a positive meniscus lens L12 having a convex surface toward the object side, the lenses being arranged in order from an object side along an optical axis. The negative lens L11 has aspherical lens surfaces on both sides.

The second lens group G2 includes a positive meniscus lens L21 having a convex surface toward the object side, a biconvex positive lens L22, and a negative meniscus lens L23 having a convex surface toward the object side, the lenses being arranged in order from an object side along an optical axis. The positive meniscus lens L21 has aspherical lens surfaces on both sides. The positive lens L22 has an aspherical lens surface on the object side.

The third lens group G3 includes a negative meniscus lens L31 having a concave surface toward the object side, and a positive meniscus lens L32 having a concave surface toward the object side, the lenses being arranged in order from an object side along an optical axis. The positive meniscus lens L32 has an aspherical lens surface on the image side.

The fourth lens group G4 includes a negative meniscus lens L41 having a concave surface toward the object side. The negative meniscus lens L41 has an aspherical lens surface on the object side.

The fifth lens group G5 includes a positive meniscus lens L51 having a concave surface toward the object side. The positive meniscus lens L51 has an aspherical lens surface on the image side. The image surface I is disposed on the image side of the fifth lens group G5.

In the present example, the second lens group G2, the third lens group G3, the fourth lens group G4, and the fifth lens group G5 serve as the rear group GR having positive refractive power as a whole. The fifth lens group G5 corresponds to the final lens group GE disposed closest to the image side in the rear group GR. The entire third lens group G3 serves as the focusing group GF that moves along the optical axis upon focusing. Upon focusing on from an infinite distance object to a close distance object, the focusing group GF (entire third lens group G3) moves to the object side along the optical axis. The fourth lens group G4 (negative meniscus lens L41) and the fifth lens group G5 (positive meniscus lens L51) serve as the image-side lens group GFR of lenses disposed closer to the image side than the focusing group GF.

Table 10 below shows data values of the zoom optical system according to the tenth example.

TABLE 10
[General Data]

| | |
|---|---|
| Zooming ratio = 1.636 | |
| fF = 39.607 | |
| fRw = 14.368 | fRt = 19.725 |
| fFRw = −38.346 | fFRt = −47.636 |
| fRPF = 19.063 | fRPR = 92.773 |
| βRw = −0.520 | βRt = −0.827 |

| | W | M | T |
|---|---|---|---|
| f | 29.700 | 38.100 | 48.600 |
| FNO | 4.860 | 5.710 | 6.670 |
| ω | 36.990 | 30.866 | 24.530 |
| Y | 19.910 | 21.600 | 21.600 |
| TL | 53.000 | 53.500 | 56.560 |
| Bf | 9.350 | 9.350 | 9.350 |

[Lens Data]

| Surface | | | | |
|---|---|---|---|---|
| Number | R | D | nd | νd |
| 1* | −30.22701 | 0.70000 | 1.592450 | 66.92 |
| 2* | 36.12436 | 0.25453 | | |
| 3 | 30.95344 | 1.15584 | 1.922860 | 20.88 |
| 4 | 46.70993 | (D4) | | |
| 5 | ∞ | 0.75000 | | (Aperture |
| | | | | Stop S) |
| 6* | 9.39854 | 2.20000 | 1.592550 | 67.86 |
| 7* | 27.34671 | 0.51079 | | |
| 8* | 25.75786 | 2.17114 | 1.497103 | 81.56 |
| 9 | −22.85474 | 0.10000 | | |
| 10 | 18.36723 | 0.60000 | 1.805180 | 25.45 |
| 11 | 10.11386 | (D11) | | |
| 12 | −10.75318 | 0.55000 | 1.647690 | 33.72 |
| 13 | −29.87660 | 0.90072 | | |
| 14 | −112.83117 | 3.80151 | 1.806040 | 40.74 |
| 15* | −13.08031 | (D15) | | |
| 16* | −13.03175 | 1.10000 | 1.592550 | 67.86 |
| 17 | −123.29153 | (D17) | | |
| 18 | −47.94418 | 3.31541 | 1.806040 | 40.74 |
| 19* | −30.11543 | Bf | | |

[Aspherical Surface Data]

1st Surface
κ = 1.0000, A4 = 2.22481E−05, A6 = 1.01445E−07,
A8 = −4.79173E−10, A10 = 0.00000E+00
2nd Surface
κ = 1.0000, A4 = 1.60025E−05, A6 = 1.58116E−07,
A8 = 0.00000E+00, A10 = 0.00000E+00
6th Surface
κ = 1.0000, A4 = 3.49725E−04, A6 = 3.83667E−06,
A8 = 0.00000E+00, A10 = 0.00000E+00
7th Surface
κ = 1.0000, A4 = 1.47564E−03, A6 = −3.55272E−06,
A8 = 0.00000E+00, A10 = 0.00000E+00
8th Surface
κ = 1.0000, A4 = 9.92751E−04, A6 = −1.52345E−05,
A8 = 0.00000E+00, A10 = 0.00000E+00
15th Surface
κ = 1.0000, A4 = 4.70062E−05, A6 = 1.55390E−07,
A8 = 0.00000E+00, A10 = 0.00000E+00
16th Surface
κ = 1.0000, A4 = 6.63363E−05, A6 = 4.07593E−08,
A8 = 0.00000E+00, A10 = 0.00000E+00
19th Surface
κ = 1.0000, A4 = 1.37067E−05, A6 = −3.22794E−08,
A8 = 0.00000E+00, A10 = 0.00000E+00

[Variable Distance Data]

| | | |
|---|---|---|
| W | M | T |

Upon focusing on infinity

| | | | |
|---|---|---|---|
| Focal length | 29.700 | 38.100 | 48.600 |
| Distance | ∞ | ∞ | ∞ |
| D4 | 8.46288 | 4.50520 | 0.78230 |
| D11 | 6.58757 | 6.69428 | 7.03152 |
| D15 | 6.16194 | 5.33365 | 5.04300 |
| D17 | 3.03775 | 8.84685 | 14.68335 |

Upon focusing on a very short distance object

| | | | |
|---|---|---|---|
| Magnification | −0.09468 | −0.12283 | −0.15875 |
| Distance | 300.0000 | 300.0000 | 300.0000 |
| D4 | 8.46288 | 4.50520 | 0.78230 |
| D11 | 3.98574 | 3.68930 | 3.48054 |
| D15 | 8.76377 | 8.33863 | 8.59397 |
| D17 | 3.03775 | 8.84685 | 14.68335 |

[Lens Group Data]

| | First | Focal |
|---|---|---|
| Group | surface | length |
| G1 | 1 | −38.500 |
| G2 | 6 | 19.063 |
| G3 | 12 | 39.607 |
| G4 | 16 | −24.684 |
| G5 | 18 | 92.773 |

FIG. 20A is a variety of aberration diagrams of the zoom optical system according to the tenth example upon focusing on infinity in the wide-angle end state. FIG. 20B is a variety of aberration diagrams of the zoom optical system according to the tenth example upon focusing on infinity in the telephoto end state. From the variety of aberration diagrams, it can be understood that the zoom optical system according to the tenth example has a variety of aberrations excellently corrected in both the wide-angle end state and the telephoto end state and has excellent imaging performance.

### Eleventh Example

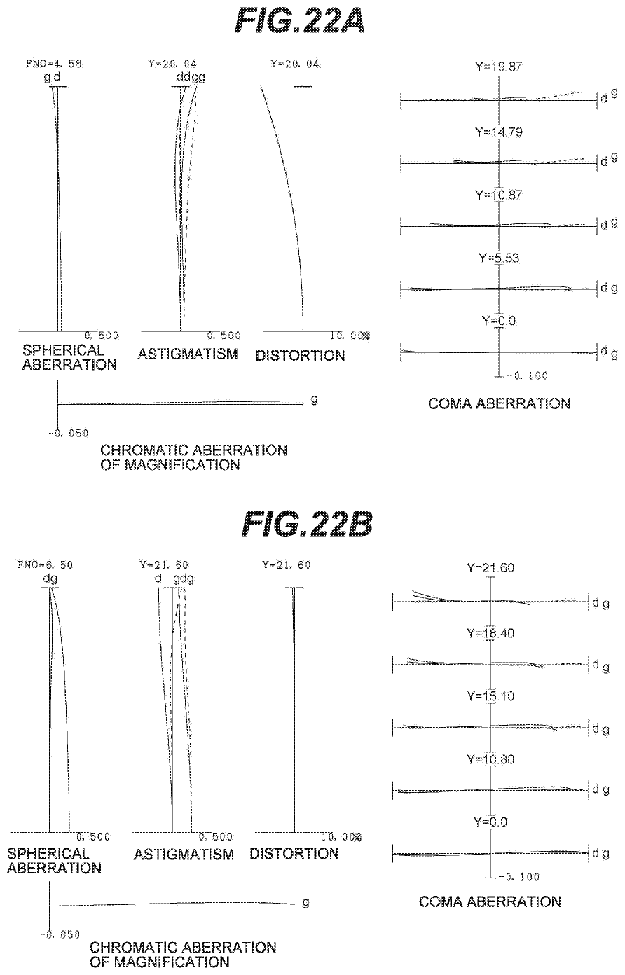

The eleventh example will be described below with reference to FIGS. 21, 22A, 22B and Table 11. FIG. 21 is a diagram showing a lens configuration of the zoom optical system according to the eleventh example. The zoom optical system according to the eleventh example ZL(11) comprises a first lens group G1 having negative refractive power, an aperture stop S, a second lens group G2 having positive refractive power, a third lens group G3 having positive refractive power, a fourth lens group G4 having negative refractive power, and a fifth lens group G5 having positive refractive power, the lens groups being arranged in order from an object side along an optical axis. Upon zooming from the wide-angle end state (W) to the telephoto end state (T), the first lens group G1, the second lens group G2, the third lens group G3, and the fourth lens group G4 move to the object side along the optical axis, and the space between the lens groups adjacent to each other changes. Upon zooming, the aperture stop S moves along the optical axis together with the second lens group G2 and the position of the fifth lens group G5 is fixed relative to the image surface I.

The first lens group G1 includes a biconcave negative lens L11, and a positive meniscus lens L12 having a convex surface toward the object side, the lenses being arranged in order from an object side along an optical axis. The negative lens L11 has aspherical lens surfaces on both sides.

The second lens group G2 includes a biconvex positive lens L21, and a negative meniscus lens L22 having a convex surface toward the object side, the lenses being arranged in order from an object side along an optical axis. The positive lens L21 has aspherical lens surfaces on both sides.

The third lens group G3 includes a negative meniscus lens L31 having a concave surface toward the object side, and a biconvex positive lens L32, the lenses being arranged in order from an object side along an optical axis. The positive lens L32 has an aspherical lens surface on the image side.

The fourth lens group G4 includes a negative meniscus lens L41 having a convex surface toward the object side, and a negative meniscus lens L42 having a concave surface toward the object side, the lenses being arranged in order from an object side along an optical axis. The negative meniscus lens L42 has an aspherical lens surface on the image side.

The fifth lens group G5 includes a positive meniscus lens L51 having a concave surface toward the object side. The positive meniscus lens L51 has an aspherical lens surface on the image side. The image surface I is disposed on the image side of the fifth lens group G5.

In the present example, the second lens group G2, the third lens group G3, the fourth lens group G4, and the fifth lens group G5 serve as the rear group GR having positive refractive power as a whole. The fifth lens group G5 corresponds to the final lens group GE disposed closest to the image side in the rear group GR. The entire third lens group G3 serves as the focusing group GF that moves along the optical axis upon focusing. Upon focusing on from an infinite distance object to a close distance object, the focusing group GF (entire third lens group G3) moves to the object side along the optical axis. The fourth lens group G4 (negative meniscus lens L41 and negative meniscus lens L42) and the fifth lens group G5 (positive meniscus lens L51) serve as the image-side lens group GFR of lenses disposed closer to the image side than the focusing group GF.

Table 11 below shows data values of the zoom optical system according to the eleventh example.

TABLE 11
[General Data]

| | |
|---|---|
| Zooming ratio = 1.636 | |
| fF = 31.496 | |
| fRw = 18.762 | fRt = 37.924 |
| fFRw = −36.619 | fFRt = −56.429 |
| fRPF = 23.697 | fRPR = 68.376 |
| βRw = −0.461 | βRt = −0.831 |

| | W | M | T |
|---|---|---|---|
| f | 29.700 | 38.000 | 48.600 |
| FNO | 4.580 | 5.430 | 6.500 |
| ω | 37.080 | 30.530 | 24.080 |
| Y | 20.040 | 21.600 | 21.600 |
| TL | 54.950 | 55.910 | 59.420 |
| Bf | 9.400 | 9.400 | 9.400 |

[Lens Data]

| Surface | | | | |
|---|---|---|---|---|
| Number | R | D | nd | νd |
| 1* | −42.08161 | 0.70000 | 1.592550 | 67.86 |
| 2* | 19.04481 | 0.7948 | | |
| 3 | 24.04182 | 1.50000 | 1.850260 | 32.35 |
| 4 | 76.98855 | (D4) | | |
| 5 | ∞ | 0.75000 | | (Aperture |
| | | | | Stop S) |
| 6* | 10.14764 | 2.30492 | 1.497103 | 81.56 |
| 7* | −41.88647 | 0.10000 | | |
| 8 | 10.76220 | 0.85000 | 1.846660 | 23.80 |
| 9 | 8.06657 | (D9) | | |
| 10 | −9.84224 | 0.60000 | 1.647690 | 33.72 |
| 11 | −30.44625 | 1.18506 | | |
| 12 | 302.30818 | 3.12363 | 1.773870 | 47.25 |
| 13* | −12.17516 | (D13) | | |
| 14 | 69.03850 | 1.05590 | 1.667550 | 41.87 |
| 15 | 23.59872 | 10.14456 | | |
| 16 | −13.80249 | 1.10000 | 1.603000 | 65.44 |
| 17* | −33.16908 | (D17) | | |
| 18 | −500.00000 | 4.50318 | 1.804400 | 39.61 |
| 19* | −49.74990 | Bf | | |

[Aspherical Surface Data]

1st Surface
κ = 1.0000, A4 = −4.37082E−07, A6 = 1.20726E−08,
A8 = −7.58568E−11, A10 = 0.00000E+00
2nd Surface
κ = 1.0000, A4 = −1.47336E−05, A6 = −1.76298E−08,
A8 = 0.00000E+00, A10 = 0.00000E+00
6th Surface
κ = 1.0000, A4 = −7.82571E−05, A6 = −4.39086E−07,
A8 = 0.00000E+00, A10 = 0.00000E+00
7th Surface
κ = 1.0000, A4 = 2.97493E−05, A6 = −3.34092E−08,
A8 = 0.00000E+00, A10−0.00000E+00
13th Surface
κ = 1.0000, A4 = 6.63179E−05, A6 = 2.88117E−07,
A8 = 0.00000E+00, A10 = 0.00000E+00
17th Surface
κ = 1.0000, A4 = −2.73274E−05, A6 = 1.19063E−08,
A8 = 0.00000E+00, A10 = 0.00000E+00
19th Surface
κ = 1.0000, A4 = 2.70508E−06, A6 = −2.22490E−09,
A8 = 0.00000E+00, A10 = 0.00000E+00

[Variable Distance Data]

| | | |
|---|---|---|
| W | M | T |

Upon focusing on infinity

| | | | |
|---|---|---|---|
| Focal length | 29.700 | 38.000 | 48.600 |
| Distance | ∞ | ∞ | ∞ |
| D4 | 9.13726 | 4.49172 | 0.75000 |
| D9 | 4.33920 | 4.81383 | 5.20970 |
| D13 | 2.65195 | 1.72334 | 0.90000 |
| D17 | 0.70000 | 6.76704 | 14.44365 |

Upon focusing on a very short distance object

| | | | |
|---|---|---|---|
| Magnification | −0.09640 | −0.12487 | −0.16166 |
| Distance | 300.0000 | 300.0000 | 300.0000 |
| D4 | 9.13726 | 4.49172 | 0.75000 |
| D9 | 2.82451 | 3.00662 | 3.08197 |
| D13 | 4.14864 | 3.53055 | 3.02772 |
| D17 | 0.70000 | 6.76704 | 14.44365 |

[Lens Group Data]

| | First | Focal |
|---|---|---|
| Group | surface | length |
| G1 | 1 | −49.718 |
| G2 | 6 | 23.697 |
| G3 | 10 | 31.496 |
| G4 | 14 | −20.966 |
| G5 | 18 | 68.376 |

FIG. 22A is a variety of aberration diagrams of the zoom optical system according to the eleventh example upon focusing on infinity in the wide-angle end state. FIG. 22B is a variety of aberration diagrams of the zoom optical system according to the eleventh example upon focusing on infinity in the telephoto end state. From the variety of aberration diagrams, it can be understood that the zoom optical system according to the eleventh example has a variety of aberrations excellently corrected in both the wide-angle end state and the telephoto end state and has excellent imaging performance.

The following presents a table of [Conditional expression correspondence value]. The table collectively lists values corresponding to Conditional Expressions (1) to (23) for all examples (the first to eleventh examples).

0.90<TLt/ft<1.50 Conditional Expression (1)

1.50<TLw/fw<2.30 Conditional Expression (2)

0.50<(−f1)/TLw<1.50 Conditional Expression (3)

0.35<(−f1)/TLt<1.25 Conditional Expression (4)

1.50<ft/(−fF)<10.00 Conditional Expression (5)

0.70<fw/(−fF)<7.00 Conditional Expression (6)

1.00<fFRw/(−fF)<7.00 Conditional Expression (7)

1.00<fFRt/(−fF)<7.00 Conditional Expression (8)

0.50<fRPF/(−fF)<3.00 Conditional Expression (9)

0.50<fRw/(−fF)<4.00 Conditional Expression (10)

0.50<fRt/(−fF)<5.00 Conditional Expression (11)

0.50<ft/fF<10.00 Conditional Expression (12)

0.30<fw/fF<7.00 Conditional Expression (13)

0.30<(−fFRw)/fF<7.00 Conditional Expression (14)

0.30<(−fFRt)/fF<7.00 Conditional Expression (15)

0.20<fRPF/fF<3.00 Conditional Expression (16)

0.15<fRw/fF<4.00 Conditional Expression (17)

0.15<fRt/fF<5.00 Conditional Expression (18)

0.10<fRPF/fRPR<0.60 Conditional Expression (19)

0.05<Bfw/fRPR<0.35 Conditional Expression (20)

60.00°<2ωw<90.00° Conditional Expression (21)

1.50<(−f1)/fRw<3.00 Conditional Expression (22)

0.50<(−f1)/fRt<2.50 Conditional Expression (23)

[Conditional Expression Corresponding Value](First to Third Example)

| Conditional | First | Second | Third |
|---|---|---|---|
| Expression | Example | Example | Example |
| (1) | 1.136 | 1.136 | 1.135 |
| (2) | 1.916 | 1.916 | 1.914 |
| (3) | 0.785 | 0.789 | 0.784 |
| (4) | 0.785 | 0.789 | 0.784 |
| (5) | 3.600 | 3.594 | 3.611 |
| (6) | 2.134 | 2.131 | 2.142 |
| (7) | 2.047 | 2.032 | 2.030 |
| (8) | 2.284 | 2.267 | 2.264 |
| (9) | 1.450 | 1.162 | 1.167 |
| (10) | 1.665 | 1.664 | 1.668 |
| (11) | 2.047 | 2.057 | 2.063 |
| (12) | — | — | — |
| (13) | — | — | — |
| (14) | — | — | — |
| (15) | — | — | — |
| (16) | — | — | — |
| (17) | — | — | — |
| (18) | — | — | — |
| (19) | 0.314 | 0.255 | 0.258 |
| (20) | 0.166 | 0.168 | 0.170 |
| (21) | 75.740 | 75.733 | 75.722 |
| (22) | 1.928 | 1.935 | 1.927 |
| (23) | 1.569 | 1.565 | 1.558 |

[Conditional Expression Corresponding Value] (Fourth to Sixth Example)

| Conditional | Fourth | Fifth | Sixth |
|---|---|---|---|
| Expression | Example | Example | Example |
| (1) | 1.109 | 1.102 | 1.138 |
| (2) | 1.870 | 1.860 | 1.921 |
| (3) | 0.851 | 0.760 | 0.785 |
| (4) | 0.851 | 0.756 | 0.785 |
| (5) | 2.040 | 2.058 | 2.821 |
| (6) | 1.209 | 1.220 | 1.671 |
| (7) | 2.109 | 2.391 | 1.837 |
| (8) | 2.109 | 2.391 | 1.991 |
| (9) | 0.728 | 0.701 | 1.012 |
| (10) | 0.968 | 0.934 | 1.313 |
| (11) | 1.295 | 1.182 | 1.655 |
| (12) | — | — | — |
| (13) | — | — | — |
| (14) | — | — | — |
| (15) | — | — | — |
| (16) | — | — | — |
| (17) | — | — | — |
| (18) | — | — | — |
| (19) | 0.345 | 0.228 | 0.280 |
| (20) | 0.206 | 0.142 | 0.166 |
| (21) | 75.480 | 75.669 | 76.494 |
| (22) | 1.990 | 1.836 | 1.919 |
| (23) | 1.487 | 1.450 | 1.523 |

[Conditional Expression Corresponding Value] (Seventh to Nineth Example)

| Conditional | Seventh | Eighth | Nineth |
|---|---|---|---|
| Expression | Example | Example | Example |
| (1) | 1.132 | 1.131 | 1.164 |
| (2) | 1.852 | 1.850 | 1.904 |
| (3) | 0.908 | 1.066 | 1.059 |
| (4) | 0.875 | 0.959 | 0.992 |
| (5) | — | — | — |
| (6) | — | — | — |
| (7) | — | — | — |
| (8) | — | — | — |
| (9) | — | — | — |
| (10) | — | — | — |
| (11) | — | — | — |
| (12) | 1.241 | 1.845 | 1.130 |
| (13) | 0.758 | 1.128 | 0.691 |
| (14) | 1.060 | 1.128 | 1.246 |
| (15) | 1.529 | 2.040 | 1.772 |
| (16) | 0.535 | 0.824 | 0.551 |
| (17) | 0.577 | 0.988 | 0.654 |
| (18) | 0.742 | 2.210 | 1.114 |
| (19) | 0.298 | 0.392 | 0.295 |
| (20) | 0.133 | 0.170 | 0.117 |
| (21) | 73.635 | 73.209 | 73.904 |
| (22) | 2.130 | 2.025 | 1.996 |
| (23) | 1.656 | 0.906 | 1.171 |

[Conditional Expression Corresponding Value] (Tenth to Eleventh Example)

| Conditional | Tenth | Eleventh |
|---|---|---|
| Expression | Example | Example |
| (1) | 1.142 | 1.223 |
| (2) | 1.869 | 2.001 |
| (3) | 0.770 | 0.905 |
| (4) | 0.694 | 0.837 |
| (5) | — | — |
| (6) | — | — |
| (7) | — | — |
| (8) | — | — |
| (9) | — | — |
| (10) | — | — |
| (11) | — | — |
| (12) | 1.227 | 1.543 |
| (13) | 0.750 | 0.943 |
| (14) | 0.968 | 1.163 |
| (15) | 1.203 | 1.792 |
| (16) | 0.481 | 0.752 |
| (17) | 0.363 | 0.596 |
| (18) | 0.498 | 1.204 |
| (19) | 0.205 | 0.347 |
| (20) | 0.101 | 0.138 |
| (21) | 73.971 | 74.162 |
| (22) | 2.680 | 2.650 |
| (23) | 1.952 | 1.311 |

According to the above-described examples, it is possible to achieve a zoom optical system having favorable optical performance with a small size.

The above-described examples are specific examples of the present application invention, and the present application invention is not limited thereto.

Contents of the following description may be applied as appropriate without losing the optical performance of a zoom optical system of the present embodiment.

Each above-described example of the zoom optical system of the present embodiment has a four-group configuration or a five-group configuration, but the present application is not limited thereto and the zoom optical system may have any other group configuration (for example, a six-group or seven-group configuration). Specifically, a lens or a lens group may be added closest to the object side or the image surface side in the zoom optical system of the present embodiment. Note that a lens group means a part including at least one lens and separated at an air distance that changes upon zooming.

The focusing lens groups may perform focusing on from an infinite distance object to a close distance object by moving one or a plurality of lens groups or a partial lens group in the optical axis direction. The focusing lens groups are also applicable to automatic focusing and also suitable for automatic focusing motor drive (using an ultrasonic wave motor or the like).

A lens group or a partial lens group may be moved with a component in a direction orthogonal to the optical axis or may be rotationally moved (swung) in an in-plane direction including the optical axis, thereby achieving a vibration-proof lens group that corrects image blur causes by camera shake.

A lens surface may be so formed as to be a spherical surface, a flat surface, or an aspheric surface. In the case where a lens surface is a spherical or flat surface, the lens is readily processed, assembled, and adjusted, whereby degradation in the optical performance due to errors in the lens processing, assembly, and adjustment is preferably avoided. Further, even when an image plane is shifted, the amount of degradation in drawing performance is preferably small.

In the case where the lens surface is an aspheric surface, the aspheric surface may be any of a ground aspheric surface, a glass molded aspheric surface that is a glass surface so molded in a die as to have an aspheric shape, and a composite aspheric surface that is a glass surface on which aspherically shaped resin is formed. The lens surface may instead be a diffractive surface, or the lenses may be any of a distributed index lens (GRIN lens) or a plastic lens.

The aperture stop is preferably disposed between the first lens group and the second lens group, but no member as an aperture stop may be provided and the frame of a lens may serve as the aperture stop.

Each lens surface may be provided with an antireflection film having high transmittance over a wide wavelength range to achieve good optical performance that reduces flare and ghost and achieves high contrast.

EXPLANATION OF NUMERALS AND CHARACTERS

| | |
|---|---|
| G1 first lens group | G2 second lens group |
| G3 third lens group | G4 fourth lens group |
| G5 fifth lens group | |
| I image surface | S aperture stop |

1. A zoom optical system comprising a first lens group and a rear group arranged in order from an object side along an optical axis, the first lens group having negative refractive power, the rear group including at least one lens group, wherein
a space between lens groups adjacent to each other changes at zooming, and
the following conditional expression is satisfied:
0.90<TLt/ft<1.50
where
TLt: entire length of the zoom optical system in a telephoto end state, and
ft: focal length of the zoom optical system in the telephoto end state.

2. A zoom optical system comprising a first lens group and a rear group arranged in order from an object side along an optical axis, the first lens group having negative refractive power, the rear group including at least one lens group, wherein
a space between lens groups adjacent to each other changes at zooming, and
the following conditional expression is satisfied:
1.50<TLw/fw<2.30
where
TLw: entire length of the zoom optical system in a wide-angle end state, and
fw: focal length of the zoom optical system in the wide-angle end state.

3. A zoom optical system comprising a first lens group and a rear group arranged in order from an object side along an optical axis, the first lens group having negative refractive power, the rear group including at least one lens group, wherein
a space between lens groups adjacent to each other changes at zooming, and
the following conditional expression is satisfied:
0.50<(−f1)/TLw<1.50
where
f1: focal length of the first lens group, and
TLw: entire length of the zoom optical system in a wide-angle end state.

4. A zoom optical system comprising a first lens group and a rear group arranged in order from an object side along an optical axis, the first lens group having negative refractive power, the rear group including at least one lens group, wherein
a space between lens groups adjacent to each other changes at zooming, and
the following conditional expression is satisfied:
0.35<(−f1)/TLt<1.25
where
f1: focal length of the first lens group, and
TLt: entire length of the zoom optical system in a telephoto end state.

5. The zoom optical system according to claim 1, wherein at least part of any one lens group in the at least one lens group of the rear group is a focusing group that moves along the optical axis upon focusing.

6. The zoom optical system according to claim 5, wherein
the focusing group has negative refractive power, and
the following conditional expression is satisfied:
1.50<ft/(−fF)<10.00
where
fF: focal length of the focusing group.

7. The zoom optical system according to claim 5, wherein
the focusing group has negative refractive power, and
the following conditional expression is satisfied:
0.70<fw/(−fF)<7.00
where
fw: focal length of the zoom optical system in a wide-angle end state, and
fF: focal length of the focusing group.

8. The zoom optical system according to claim 5, wherein
the focusing group has negative refractive power, and
the following conditional expression is satisfied:
1.00<fFRw/(−fF)<7.00
where
fFRw: focal length of a lens group of lenses disposed closer to an image side than the focusing group in a wide-angle end state, and
fF: focal length of the focusing group.

9. The zoom optical system according to claim 5, wherein
the focusing group has negative refractive power, and
the following conditional expression is satisfied:
1.00<fFRt/(−fF)<7.00
where
fFRt: focal length of a lens group of lenses disposed closer to an image side than the focusing group in a telephoto end state, and
fF: focal length of the focusing group.

10. The zoom optical system according to claim 5, wherein
the focusing group has negative refractive power, and
the following conditional expression is satisfied:
0.50<fRPF/(−fF)<3.00
where
fRPF: focal length of a lens group having positive refractive power and disposed closest to the object side in the at least one lens group of the rear group, and
fF: focal length of the focusing group.

11. The zoom optical system according to claim 5, wherein
the focusing group has negative refractive power, and
the following conditional expression is satisfied:
0.50<fRw/(−fF)<4.00
where
fRw: focal length of the rear group in a wide-angle end state, and
fF: focal length of the focusing group.

12. The zoom optical system according to claim 5, wherein
the focusing group has negative refractive power, and
the following conditional expression is satisfied:
0.50<fRt/(−fF)<5.00
where
fRt: focal length of the rear group in a telephoto end state, and
fF: focal length of the focusing group.

13. The zoom optical system according to claim 5, wherein
the focusing group has positive refractive power, and
the following conditional expression is satisfied:
0.50<ft/fF<10.00
where,
fF: focal length of the focusing group.

14. The zoom optical system according to claim 5, wherein
the focusing group has positive refractive power, and
the following conditional expression is satisfied:
0.30<fw/fF<7.00
where
fw: focal length of the zoom optical system in a wide-angle end state, and
fF: focal length of the focusing group.

15. The zoom optical system according to claim 5, wherein
the focusing group has positive refractive power, and
the following conditional expression is satisfied:
0.30<(−fFRw)/fF<7.00
where
fFRw: focal length of a lens group of lenses disposed closer to an image side than the focusing group in a wide-angle end state, and
fF: focal length of the focusing group.

16. The zoom optical system according to claim 5, wherein
the focusing group has positive refractive power, and
the following conditional expression is satisfied:
0.30<(−fFRt)/fF<7.00
where
fFRt: focal length of a lens group of lenses disposed closer to an image side than the focusing group in a telephoto end state, and
fF: focal length of the focusing group.

17. The zoom optical system according to claim 5, wherein
the focusing group has positive refractive power, and
the following conditional expression is satisfied:
0.20<fRPF/fF<3.00
where
fRPF: focal length of a lens group having positive refractive power and disposed closest to the object side in the at least one lens group of the rear group, and
fF: focal length of the focusing group.

18. The zoom optical system according to claim 5, wherein
the focusing group has positive refractive power, and
the following conditional expression is satisfied:
0.15<fRw/fF<4.00
where
fRw: focal length of the rear group in a wide-angle end state, and
fF: focal length of the focusing group.

19. The zoom optical system according to claim 5, wherein
the focusing group has positive refractive power, and
the following conditional expression is satisfied:
0.15<fRt/fF<5.00
where
fRt: focal length of the rear group in a telephoto end state, and
fF: focal length of the focusing group.

20. The zoom optical system according to claim 5, wherein the at least one lens group of the rear group is a plurality of lens groups.

21. The zoom optical system according to claim 1, wherein the at least one lens group of the rear group includes a second lens group having positive refractive power and disposed closest to the object side in the rear group.

22. The zoom optical system according to claim 1, wherein the at least one lens group of the rear group includes a final lens group having positive refractive power and disposed closest to an image side in the rear group.

23. The zoom optical system according to claim 1, wherein the following conditional expression is satisfied:
0.10<fRPF/fRPR<0.60
where
fRPF: focal length of a lens group having positive refractive power and disposed closest to the object side in the at least one lens group of the rear group, and
fRPR: focal length of a lens group having positive refractive power and disposed closest to an image side in the at least one lens group of the rear group.

24. The zoom optical system according to claim 1, wherein the following conditional expression is satisfied:
0.05<Bfw/fRPR<0.35
where
Bfw: back focus of the zoom optical system in a wide-angle end state, and
fRPR: focal length of a lens group having positive refractive power and disposed closest to an image side in the at least one lens group of the rear group.

25. The zoom optical system according to claim 1, wherein a lens disposed closest to the object side in the rear group is a positive lens.

26. The zoom optical system according to claim 1, further comprising an aperture stop disposed between the first lens group and the rear group.

27. The zoom optical system according to claim 1, wherein the following conditional expression is satisfied:
60.00°<2ωw<90.00°
where
2ωw: full angle of view of the zoom optical system in a wide-angle end state.

28. The zoom optical system according to claim 1, wherein the following conditional expression is satisfied:
1.50<(−f1)/fRw<3.00
where
f1: focal length of the first lens group, and
fRw: focal length of the rear group in a wide-angle end state.

29. The zoom optical system according to claim 1, wherein the following conditional expression is satisfied:
0.50<(−f1)/fRt<2.50
where
f1: focal length of the first lens group, and
fRt: focal length of the rear group in a telephoto end state.

30. An optical apparatus comprising the zoom optical system according to claim 1.

31-34. (canceled)

35. A method for manufacturing a zoom optical system which comprises a first lens group and a rear group arranged in order from an object side along an optical axis, the first lens group having negative refractive power, and the rear group including at least one lens group,
the method comprising:
arranging the lens groups in a lens barrel such that a space between lens groups adjacent to each other changes at zooming; and
satisfying one or more of the following conditional expressions (A), (B), (C) and (D):
0.90<TLt/ft<1.50 (A)
1.50<TLw/fw<2.30 (B)
0.50<(−f1)/TLw<1.50 (C)
0.35<(−f1)/TLt<1.25 (D)
where
TLt: entire length of the zoom optical system in a telephoto end state,
ft: focal length of the zoom optical system in the telephoto end state,
TLw: entire length of the zoom optical system in a wide-angle end state,
fw: focal length of the zoom optical system in the wide-angle end state, and
f1: focal length of the first lens group.
